(19) United States
(12) Patent Application Publication
(10) Pub. No.: US 2005/0196629 A1
(43) Pub. Date: Sep. 8, 2005

(54) Methods of coating interior container surfaces and containers containing internal coatings

(75) Inventors: Igor Bariatinsky, Tournus (FR); Alistair Charleston, Tournus (FR); Michael Cleaver, Tournus (FR); Ulrich Leibelt, Tournus (FR); Robert Lespinasse, Tournus (FR); Paul Stenson, Gruningen (CH); Regis Garcia, Compiegne (FR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Valspar Sourcing, Inc., Minneapolis, MN (US)

(21) Appl. No.: 11/056,718

(22) Filed: Feb. 11, 2005

Related U.S. Application Data
(60) Provisional application No. 60/544,385, filed on Feb. 12, 2004.

(51) Int. Cl. B32B 27/36

(52) U.S. Cl. 428/480

(57) ABSTRACT

The present invention provides aqueous dispersions that comprise the reaction product of (A) a polyester that is a reaction product of at least a (i) polybasic acid containing at least two carboxyl groups and (ii) a polyhydric alcohol containing at least two hydroxyl groups and (B) at least (i) a (meth)acrylic acid ester, and (ii) an ethylenically unsaturated mono- or multi-functional acid. Also described are coating compositions containing the aqueous dispersion, methods of forming the aqueous dispersion, and metal containers bearing internal liners derived from the coating compositions with beverages or wet foodstuffs located in the metal containers and in contact with the internal liners.

### CROSS-REFERENCE TO RELATED APPLICATION(S)

This application claims the priority benefit under 35 U.S.C. §119(e) of Application Ser. No. 60/544,385 filed on Feb. 12, 2004 and incorporates by reference the entire content of Application Ser. No. 60/544,385.

### BACKGROUND

A wide variety of coatings have been used to coat interior surfaces of metal packaging containers (e.g., food or beverage cans). For example, some food or beverage cans are formed with a body portion that has an interior surface along with a first end portion that has an interior surface. Both the body portion and the first end portion are preformed from sheet metal and thereafter attached to each other to form the food or beverage can with the body portion and first end portion along with an open end. In this food or beverage can, a coating composition is applied through the open end to interior surfaces of the body portion and first end portion, and the applied coating composition is thereafter cured.

A second end portion is preformed from sheet metal, coated with the coating composition that is subsequently cured, and then attached to the food or beverage can to close the open end of the food and beverage can. For some food or beverage cans, the second end portion may be smaller than the first end portion, even though the body portion is generally uniform in cross-sectional area, to reduce the amount of metal used in the second end portion. To accommodate the smaller second end portion, the body portion, after the coating composition has been applied and cured, may be mechanically necked down to a size sufficient to accept the second end portion. These mechanical necking operations, such as spin-necking or die-necking, entail stretching operations that impart significant stress to the metal and to the cured coating that is attached to the metal. Additional stress is imparted when the second end portion is attached to the body portion of the food or beverage can.

In another aspect, the food or beverage can may be based on a “coil coating” operation wherein a coating composition is applied to a planar sheet of a suitable substrate, such as steel or aluminum, and thereafter cured. The coated substrate is then mechanically formed into coated can ends and coated can bodies. The mechanical transformation of the coated substrate into the can ends and bodies imparts significant stress to at least some portions of the coated substrate. Additional stress is imparted when the coated end portions are attached to coated can bodies to form food or beverage cans.

Coating compositions employed on interior surfaces of food or beverage containers, or applied on surfaces of components of food or beverage containers that will eventually be interior surfaces of food or beverage containers, are subject to stringent requirements, since such coating compositions are typically in contact with either food or beverages that are packaged and stored in the food or beverage containers. First, the coating composition, and components of the coating composition, should not deleteriously affect the food or beverage that is packaged and stored in the food or beverage container. Second, the food or beverage that is packaged and stored in the food or beverage container should not deleteriously affect either the coating composition or any components of the coating composition.

The coating composition may deleteriously affect packaged food or beverages in at least a couple of different ways. For example, a component of the coating composition may be transferred into the food or beverage and undesirably alter the flavor or taste of the food or beverage. As another example, a component of the coating composition with perceived health effects may be transferred into the food or beverage. For example, many current package coatings contain mobile or bound bisphenol A (“BPA”), aromatic glycidyl ether compounds, or PVC compounds. Although the balance of scientific evidence available to date indicates any small trace amounts of these compounds that might be released from existing coatings do not pose any health risks to humans, these compounds are nevertheless perceived by some people as being potentially harmful to human health. Consequently, there is a strong desire to eliminate these compounds from food contact coatings.

To avoid concerns about components with such undesirable flavor or taste effects and to avoid concerns about components with such perceived health effects, it is highly desirable to remove such components from the coating composition or otherwise prevent transfer of such components into the food or beverage. Resolution of these concerns, which may very well affect the composition of the coating composition, may negatively impact other desirable properties of the coating composition, absent diligent invention of an interactive solution that reconciles all desirable properties of the coating composition.

The packaged food or beverage may deleteriously affect the coating composition in at least one important way. For example, acidic foods or beverages may degrade the coating of the coating composition and cause the coating to blister or delaminate from the interior surface of the food or beverage can. This may shorten the life of the food or beverage can and may tend to contaminate the food or beverage with degraded coating material. Furthermore, some foods or beverages are subjected to high temperature and pressure via a retorting operation, after being packaged in the food or beverage container. Such retorting operations may deleteriously affect the coating composition. For example, such retorting may cause the coating to blister or delaminate from the interior surface of the food or beverage can.

To avoid concerns about the food or beverage, or processing conditions of packaged foods or beverages, degrading the coatings on internal surfaces of food or beverage containers, the formulation of, and/or the application technique for, the coating composition should prevent such degradation of the coating composition. Resolution of these concerns, which may very well affect the composition of the coating composition, may negatively impact other desirable properties of the coating composition, absent diligent invention of an interactive solution that reconciles all desirable properties of the coating composition.

Package coatings will desirably be capable of high-speed application to substrates, while still providing suitable performance properties for demanding end uses following cure. Coating composition application to interior surfaces of food or beverage containers typically entails spray application of the coating composition. Spray application techniques require a combination of coating composition properties to be successful. For example, the viscosity, solids content, solids uniformity within the coating composition, and interaction of these variables, are important to consistent and efficient spraying operations with minimal spraying equipment downtime. Furthermore, the viscosity, surface tension, solids content, solids uniformity within the coating composition, and interaction of these variables, are important to application of a consistent and uniform coating of the coating composition on all internal surfaces of the food or beverage can.

To assure efficient spraying operations coupled with consistent and uniform coating composition application to all internal surfaces present within the food or beverage containers, the formulation of, and/or the application technique for, the coating composition should be sufficient to support such efficient spraying operations and beneficial application properties. Accommodation of these concerns, which may very well affect the composition of the coating composition, may negatively impact other desirable properties of the coating composition, absent diligent invention of an interactive solution that reconciles all desirable properties of the coating composition.

Finally, the coating of the coating composition may very well be subjected to mechanical stress, such as stretching and other forces that may be conducive to tearing the coating or separating the coating from the food or beverage container. Such mechanical stress may arise as a result of the aforementioned necking operations where the body portion of the food or beverage container is mechanically necked down to a size sufficient to accept an end portion with a smaller cross-sectional area than the majority of the body portion. Such mechanical stress may also arise upon formation of components of the food or beverage container that are pre-coated with the coating composition and upon attachment of such components to each other in the course of forming or completing the food or beverage container.

To assure a structurally sound coating of the coating composition in completed food or beverage cans, the coating should be sufficiently flexible, extensible, ductile, and adhesive to withstand tearing, fracture, delamination, and/or separation during formation, working, and assembly of coated components or portions of food or beverage cans. Accommodation of these concerns, which may very well affect the composition of the coating composition, may negatively impact other desirable properties of the coating composition, absent diligent invention of an interactive solution that reconciles all desirable properties of the coating composition.

From the foregoing, it will be appreciated that a need exists in the art for a coating composition particularly adapted to efficient spray application of a uniform and complete coating of the coating composition to all internal surfaces of the food or beverage can, or to all surfaces of can components that will be internal surfaces upon complete assembly of the can. Furthermore, the completed coating that is included on internal surfaces of the food or beverage can should not contain extractible quantities of undesirable compounds and should be resistant to degradation by foods or beverages contained in the can, or processing conditions of packaged foods or beverages. Finally, the completed coating should be sufficiently flexible, extensible, ductile, and adhesive to withstand tearing, fracture, delamination, and separation during formation, working and assembly of coated components or portions of food or beverage cans. Such coated packaging containers, coating compositions, completed coatings, and methods for preparing coated packaging containers are disclosed and described herein.

### SUMMARY

In one embodiment, the present invention relates to an article that includes (1) a metal container with an interior surface and an exterior surface and (2) a coating on at least a portion of the interior surface of the container. The coating includes an aqueous dispersion of an at least partially neutralized polyester acrylate, where the polyester acrylate is a reaction product of (A) a polyester that is a reaction product of a first collection of components including a (i) polybasic acid that contains at least two carboxyl groups and (ii) a polyhydric alcohol that contains at least two hydroxyl groups and (B) a second collection of components including (i) a (meth)acrylic acid ester, (ii) an ethylenically unsaturated mono- or multi-functional acid, and (iii), optionally, a vinyl compound.

In another embodiment, the present invention relates to an article that includes (1) a metal container having an interior surface and an exterior surface and (2) a coating on at least a portion of the interior surface of the container. In this embodiment, the coating includes an aqueous dispersion of an at least partially neutralized polyester acrylate, where the coating is substantially free of mobile BPA and aromatic glycidyl ether compounds.

In a further embodiment, the present invention relates to an article that includes (1) a metal container having an interior surface and an exterior surface, where the interior surface defines a space within the metal container; (2) a liner that is attached to and covering the interior surface of the container, where the liner is derived from coating composition comprising an aqueous dispersion of an at least partially neutralized polyester acrylate; and (3) a beverage or a wet foodstuff that is located within the space and in contact with the liner.

In other embodiments, the present invention relates to various methods of coating interior portions of a metal container with coating compositions that include an aqueous dispersion of a polyester acrylate.

### BRIEF DESCRIPTION OF THE DRAWINGS

FIG. 1 is a graph of particle diameter versus particle volume percent for particles present in an aqueous dispersion of polyester acrylate produced in accordance with the present invention.

FIG. 2 is a graph of enamel rating versus cured coating weight for tinplate cans coated with coating compositions of the present invention.

### DEFINITIONS

When it is stated herein that a composition of the present invention is “substantially free” of a particular mobile compound, this use of the term “substantially free” means the noted composition contains less than 1000 parts by weight of the recited mobile compound per million parts by weight (ppm) of the noted composition. When it is stated herein that a composition of the present invention is “essentially free” of a particular mobile compound, this use of the term “essentially free” means the noted composition contains less than 100 parts by weight of the recited mobile compound per million parts by weight (ppm) of the noted composition. When it is stated herein that a composition of the present invention is “essentially completely free” of a particular mobile compound, this use of the term “essentially completely free” means the noted composition contains less than 5 parts by weight of the recited mobile compound per million parts by weight of the noted composition. When it is stated herein that a composition of the present invention is “completely free” of a particular mobile compound, this use of the term “completely free” means the noted composition contains less than 20 parts by weight of the recited mobile compound per billion parts by weight of the noted composition.

When it is stated herein that a particular compound present in a cured coating is “mobile,” this use of the term “mobile” means the compound can be extracted from the cured coating when the cured coating (typically at an application of ˜1 mg/cm² of the substrate surface) is exposed to a 10 weight percent aqueous solution of ethanol for two hours at 121° C. followed by exposure of the cured coating in the aqueous solution of ethanol for 10 days at 49° C.

If the aforementioned phrases (substantially free, essentially free, essentially completely free, completely free) are used for a particular compound without the term “mobile” (e.g., “substantially free of XYZ compound”) in relation to a particular composition of the present invention, then the particular composition contains less than the aforementioned amount (associated, respectively, with the aforementioned phrases) of the recited compound, no matter whether the compound is or is not bound to a constituent of the cured coating.

As used herein, the term “acid number” (or “acid value”) of a polymer means the number of milligrams of potassium hydroxide required to neutralize the pendant carboxylate groups in one gram of the polymer. As used herein, the term “hydroxyl number” (or “hydroxyl value” or “OH number”) of a polymer means the number of milligrams of potassium hydroxide required to neutralize the pendant hydroxyl groups in one gram of the polymer.

As used herein, the term “dispersion” means a multi-phase system in which a solid phase of small, solid particles is uniformly dispersed throughout a liquid phase, where the solid phase of small, solid particles is insoluble or only negligibly soluble in the liquid phase and in components of the liquid phase.

As used herein, the term “aqueous dispersion” means a dispersion where the liquid phase is water or includes at least about 10 weight percent water, based on the total weight of the liquid phase.

As used herein, the following terms have the indicated meanings:
the term “organic group” means a hydrocarbon (i.e., hydrocarbyl) group that may optionally include elements (such as oxygen, nitrogen, sulfur, and silicon) other than carbon and hydrogen in the chain of the hydrocarbon group that is classified as an aliphatic group, cyclic group, or a combination of aliphatic and cyclic groups (e.g., alkaryl and aralkyl groups).
the term “aliphatic group” means a saturated or unsaturated, linear or branched hydrocarbon group. This term is used to encompass alkyl, alkenyl, and alkynyl groups, for example.
the term “alkyl group” means a saturated linear or branched hydrocarbon group including, for example, methyl, ethyl, isopropyl, t-butyl, heptyl, dodecyl, octadecyl, amyl, 2-ethylhexyl, and the like.
the term “alkenyl group” means an unsaturated linear or branched hydrocarbon group with one or more carbon-carbon double bonds, such as a vinyl group.
the term “alkynyl group” means an unsaturated linear or branched hydrocarbon group that contains one or more carbon-carbon triple bonds.
the term “cyclic group” means a closed ring hydrocarbon group that is classified as an alicyclic group, aromatic group, or heterocyclic group.
the term “alicyclic group” means a cyclic hydrocarbon group having properties resembling those of aliphatic groups.
the term “aromatic group” or “aryl group” means a mono- or polynuclear aromatic hydrocarbon group.
the term “heterocyclic group” means a closed ring hydrocarbon in which one or more of the atoms in the ring is an element other than carbon (e.g., nitrogen, oxygen, sulfur, etc.).
   Unless otherwise indicated herein,
the term “vinyl addition polymer” or “vinyl addition copolymer” is meant to include acrylate, methacrylate, and vinyl polymers and copolymers;
a reference to a “polymer” is also meant to include a copolymer; and
a reference to a “(meth)acrylate” compound (where “meth” is bracketed) is meant to include both acrylate and methacrylate compounds.

Substitution is contemplated on the organic groups of the polymers used in the coating compositions of the present invention. As a means of simplifying the discussion and recitation of certain terminology used throughout this application, the terms “group” and “moiety” are used to differentiate between chemical species that allow for substitution or that may be substituted and those that do not allow for substitution or may not be substituted. Thus, when the term “group” is used to describe a chemical substituent, the described chemical material includes the recited group (as unsubstituted) and also refers to the recited group that includes O, N, Si, or S atoms, for example, in the chain (as in an alkoxy group), as well as, carbonyl groups and other atoms or groups that are conventionally substituted in the recited group. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, the term “alkyl group” includes ether groups, haloalkyls, nitroalkyls, carboxyalkyls, hydroxyalkyls, sulfoalkyls, etc. On the other hand, the phrase “alkyl moiety” is limited to inclusion of only pure open chain saturated hydrocarbon alkyl substituents, such as methyl, ethyl, propyl, t-butyl, and the like. The term “hydrocarbyl moiety” refers to unsubstituted organic moieties containing only hydrogen and carbon.

### DETAILED DESCRIPTION

The present invention provides novel dispersions (e.g., aqueous dispersions) that are suitable for use as coating compositions on any internal surface(s) of a metal food or beverage container and methods of coating any internal surface(s) of a metal food or beverage container using these dispersions. The aqueous dispersions comprise polyester acrylate(s) that has been at least partially neutralized with a base. In one embodiment, the polyester acrylate(s) comprises the reaction product(s) of a polyester (or a mixture of polyesters) with a first collection of components, namely, (1) (meth)acrylic acid ester(s), (2) ethylenically unsaturated mono- or multi-functional acid(s), and (3), optionally, vinyl compound(s). The at least partially neutralized polyester acrylate(s) of any embodiment(s) may be dispersed in a carrier (e.g., water) with optional crosslinking agent(s) and other optional adjuvants to form aqueous dispersions of the polyester acrylate(s).

Preferred coating compositions and aqueous dispersions are substantially free of mobile BPA and aromatic glycidyl ether compounds (e.g., BADGE, BFDGE and epoxy novalacs), more preferably essentially free of these compounds, even more preferably essentially completely free of these compounds, and most preferably completely free of these compounds. The coating compositions and aqueous dispersions are also preferably substantially free of bound BPA and aromatic glycidyl ether compounds, more preferably essentially free of these compounds, most preferably essentially completely free of these compounds, and optimally completely free of these compounds.

Suitable polyesters may be obtained in accordance with conventional procedures well known to those of ordinary skill in the art by reacting a polybasic acid that contains at least two carboxyl groups per polybasic acid molecule (e.g., an at least dibasic polycarboxylic acid) with a polyhydric alcohol that contains at least two hydroxyl groups in the polyhydric alcohol molecule (e.g., an at least dihydric polyalcohol). Suitable polyester(s) may, for example, be obtained by esterifying the polybasic acid(s) and the polyhydric alcohol(s) in the presence of conventional esterification catalyst at an elevated temperature (e.g., from about 180° C. to about 240° C.) in the molten state or in the presence of inert solvents for about five to about twenty-four hours. As another example, suitable polyesters may be obtained by transesterifying polybasic acid ester(s) and the polyhydric alcohol(s) in the presence of conventional esterification catalyst at an elevated temperature (e.g., from about 180° C. to about 240° C.) in the melt or in the presence of inert solvents.

One or more polymerizable double bonds may be included in the polyester(s) by employing a polybasic acid containing polymerizable double bonds as the polybasic acid that contains at least two carboxyl groups per polybasic acid molecule and/or by employing a polyhydric alcohol containing polymerizable double bonds as the polyhydric alcohol that contains at least two hydroxyl groups per polyhydric alcohol molecule. Thus, the polybasic acid that contains at least two carboxyl groups per polybasic acid molecule and/or the polyhydric alcohol that contains at least two hydroxyl groups in the polyhydric alcohol molecule (e.g., an at least dihydric polyalcohol) may be ethylenically unsaturated.

Suitable polybasic acids that contain at least two carboxyl groups per polybasic acid molecule may be represented by the formulas R¹(COOH)C═C(COOH)R², R¹(COOH)CHCH(COOH)R², R¹(R²)C═C(COOH)R³COOH, and R¹(R²)CHCH(COOH)R³COOH, where R¹ and R² may be hydrogen, an alkyl radical of 1-8 carbon atoms, halogen, cycloalkyl of 3-7 carbon atoms, or phenyl, and R³ may be an alkylene radical of 1-6 carbon atoms. Some suitable examples of the polybasic acid that contains at least two carboxyl groups per polybasic acid molecule include phthalic acid; isophthalic acid; terephthalic acid; tetrahydrophthalic acid; hexahydrophthalic acid; endomethylenetetrahydrophthalic acid; dimethylterephthalate; maleic acid; 2-methyl maleic acid; pyromellitic acid; adipic acid; succinic acid; sebacic acid; glutaric acid; methyleneglutaric acid; glutaconic acid; azelaic acid; aconitic acid; itaconic acid; 2-methyl itaconic acid; sebacic acid; lauric acid; fumaric acid; citraconic acid; 1,2-, 1,3- or 1,4-cyclohexanedicarboxylic acid; muconic acid; mesaconic acid; camphoric acid; trimellitic acid; tricarballylic acid; tricarboxyethylene; dimethylolpropionic acid; beta-acryloxypropionic acid; derivatives of these such as any possible anhydride of any of these: and any combination of any of these in any proportion. Examples of some suitable anhydrides of the polybasic acid include unsaturated dicarboxylic acid anhydrides, such as maleic anhydride, itaconic anhydride, nonenylsuccinic anhydride, and citraconic anhydride; saturated anhydrides, such as succinic anhydride, phthalic anhydride and trimellitic anhydride; and any combination of any of these in any proportion. The polyester(s) may optionally be modified, if desired, by including a fatty acid, such as castor oil fatty acid, coconut oil fatty acid, cotton seed fatty acid, benzoic acid, or any of these in any combination and any proportion along with the polybasic acid that contains at least two carboxyl groups per polybasic acid molecule.

Some suitable examples of the polyhydric alcohol that contains at least two hydroxyl groups in the polyhydric alcohol molecule include ethylene glycol; polyethylene glycol; diethyleneglycol; triethyleneglycol; tetraethyleneglycol; hexaethyleneglycol; neopentyl glycol; 1,3- and 1,2-propyleneglycol; polypropylene glycol; 1,4-butanediol; 1,5-pentanediol; 2,2-dimethylpropanediol; 1,6-hexanediol; 1,2-cyclohexanediol; 1,4-cyclohexanedimethanol; trimethylolpropane; pentaerythritol; tricyclodecane dimethanol; glycerol; and any combination of any of these in any proportion.

The choice of the polybasic acid that contains at least two hydroxyl groups in the polybasic acid molecule is dictated by the intended end use of the coating composition and is practically unlimited. Likewise, the choice of the polyhydric alcohol that contains at least two hydroxyl groups in the polyhydric alcohol molecule is dictated by the intended end use of the coating composition and is practically unlimited. The collection of components that are reacted to form the polyester(s) will generally include at least about 20 weight percent, and more typically at least about 30 weight percent to as much as about 45 weight percent, of the polyhydric alcohol that contains at least two hydroxyl groups in the polyhydric alcohol molecule. The balance of the collection of components that are reacted to form the polyester(s) may be the polybasic acid that contains at least two carboxyl groups per polybasic acid molecule or a combination of the polybasic acid and an anhydride derivative of the polybasic acid. The concentration of the anhydride derivative of the polybasic acid may range up to about thirty weight percent of the collection of components that are reacted to form the polyester(s), but more typically ranges up to about five weight percent of the collection of components that are reacted to form the polyester(s).

Suitable polyesters will generally have an acid value of about eight or less and may have an acid value of about five or less; some embodiments of the polyester will have acid values ranging from about four to about eight. Suitable polyesters will generally have a number average molecular weight (Mₙ) ranging from as little as about 2,500 to as much as about 20,000; in some embodiments, the Mₙ of the polyesters may range from as little as about 4,000 to as much as about 16,000. In other embodiments, the Mₙ of the polyesters may generally range from as little as about 5,000 to as much as about 12,000, and may sometimes range from as little as about 3,000 to as much as about 5,000.

The acid value (i.e., acid number: “AN”) of polyesters produced according to the present invention may generally range from 0 mg KOH/gm of the polyester to as high as about 20 mg KOH/gm of the polyester. Details about determining the acid number are provided in the Property Analysis And Characterization Procedure section of this document. The hydroxyl value (i.e., hydroxyl number: or OH number) of polyesters produced according to the present invention may generally range from as low as about 20 mg KOH/gm of the polyester to as high as about 200 mg KOH/gm of the polyester. Details about determining the hydroxyl number are provided in the Property Analysis And Characterization Procedure section of this document. The hydroxyl value is a measure of the reactive potential of the polyester.

Besides the polybasic acid(s) and polyhydric alcohol(s), any desired catalyst may be included at an appropriate concentration in the reaction mixture during formation of the polyester(s). For example, the catalyst, if included, may present at a concentration up to as much as about 0.5 weight percent, based on the total weight of the polybasic acid(s), any anhydride(s) of the polybasic acid(s), and the polyhydric alcohol(s) in the reaction mixture. One suitable catalyst is the REATINOR® 932 product that is available from Reagens USA, Inc. of Pasadena, Tex. Other suitable catalysts are the FASCAT® 9100 catalyst product and the FASCAT® 4102 catalyst product that are available from Atofina of Paris, France.

The polyesters utilized in this invention include those prepared by conventional esterification or transesterification techniques. The polyester formation reaction may be conveniently carried out as a neat process in the molten phase or in the presence of suitable solvents at elevated temperatures ranging from about 180° C. to about 240° C. for about five to about twenty-four hours until polyester(s) with an acid value of about eight or less, or in some versions an acid value of about five or less, is achieved. The resulting polyester(s) may then be dissolved in additional organic solvent in preparation for formation of polyester acrylate(s) via in-situ polymerization of the collection of monomers: (1) (meth)acrylic acid ester(s), (2) ethylenically unsaturated mono- or multi-functional acid(s), and (3), optionally, vinyl compound(s), in the presence of the polyester(s).

Dispersion of the polyester acrylate(s) in water in accordance with the present invention may be carried out in any conventional manner. After at least partially neutralizing the carboxyl groups of the polyester acrylate(s) with about 0.3 to 1.5 equivalents of a base (i.e., a neutralizing agent), the at least partially neutralized polyester acrylate(s) solution may be inverted into the aqueous phase by the addition of water or alternatively may be added to water via a reverse inversion process. The pH of the final aqueous dispersion may generally range from as low as about 7 standard pH units to as high as about 10 standard pH units, or, more typically may range from as little as about 7.3 standard pH units to as high as about 8.5 standard pH units.

Examples of suitable organic solvent(s) that may be used during formation of the polyester(s) include aromatic solvents, such as SOLVESSO® 100 solvent, SOLVESSO® 150 solvent, and SOLVESSO® 200 solvent that are each available from Exxon Mobil Chemical France of Rueil Malmaison, France; xylene; and any of these in any combination and in any proportion. Examples of suitable organic solvent(s) for reacting the polyester(s) with the collection of monomers to form the polyester acrylate(s) are organic solvents that are fully or partially water-miscible, such as N-methylpyrrolidone, acetone, diacetone alcohol, 2-hydroxy-4-methyl-pentane, ethylene glycol, diethylene glycol, 1,3-butylene glycol methoxybutanol, butyl glycol, butyl ethylene glycol, ethylene glycol monoalkyl ethers (e.g., ethylene glycol methyl ether, ethylene glycol ethyl ether and ethylene glycol butyl ether), diethylene glycol, diethylene glycol monoalkyl ethers (e.g., diethylene glycol methyl ether, diethylene glycol ethyl ether and diethylene glycol butyl ether), glyme solvents (e.g., ethylene glycol dimethyl ether), diglyme solvents (e.g., diethylene glycol dimethyl ether), alcohol solvents (e.g., methyl alcohol, ethyl alcohol, propyl alcohol, n-butyl alcohol, 2-ethylhexyl alcohol, and cyclohexanol), propylene glycol, propylene glycol monoalkyl ethers {e.g., propylene glycol methyl ether (available under the DOWANOL PM tradename from The Dow Chemical Company of Midland, Mich.), propylene glycol ethyl ether, and propylene glycol butyl ether}, methyl alkyl ketones (e.g., ethylethylketone and methylisobutylketone), dipropylene glycol, and dipropylene glycol monoalkyl ethers (e.g., dipropylene glycol methyl ether, dipropylene glycol ethyl ether, and dipropylene glycol butyl ether), monoalkyl acrylates (e.g., propyl acrylate, ethyl acrylate, and butyl acrylate) and any combination of any of these in any proportion.

In the aqueous dispersion, the polyester acrylate(s) comprises reaction product(s) of the polyester (or a mixture of different polyesters) with the collection of monomers, namely, (1) (meth)acrylic acid ester(s), (2) ethylenically unsaturated mono- or multi-functional acid(s), and (3), optionally, vinyl compound(s). Surprisingly, polyester acrylate(s) formed via this reaction have been found to “mimic” or exceed the properties of traditional “1007-type”; “1009-type”; and “9-A-9-type” epoxy resins, without containing or liberating BPA or aromatic glycidyl ether compounds (e.g., BADGE, BFDGE and epoxy novalacs).

Suitable (meth)acrylic acid esters include alkyl (meth)acrylates of the formula: CH₂═C(R⁴)—CO—OR⁵ wherein R⁴ may be hydrogen or methyl, and R⁵ may be an alkyl group preferably containing one to sixteen carbon atoms. The R⁵ group may be substituted with one or more, and typically one to three, moieties such as hydroxy, halo, phenyl, and alkoxy, for example. Suitable alkyl (meth)acrylates therefore encompass hydroxy alkyl (meth)acrylates. The alkyl (meth)acrylates typically are esters of acrylic acid and/or methacrylic acid. R⁴ may generally be hydrogen or methyl, and R⁵ may generally be an alkyl group having two to eight carbon atoms. In some embodiments, R⁴may typically be hydrogen or methyl and R⁵ may be an alkyl group having two to four carbon atoms. Some non-exhaustive examples of suitable (meth)acrylic acid esters include, but are not limited to, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-hydroxyethyl (meth)acrylate, 2-ethylhexyl (meth)acrylate, cyclohexyl (meth)acrylate, decyl (meth)acrylate, isodecyl (meth)acrylate, benzyl (meth)acrylate, 2-hydroxypropyl (meth)acrylate, lauryl (meth)acrylate, isobomyl (meth)acrylate, octyl (meth)acrylate, nonyl (meth)acrylate, and any of these in any combination and in any proportion.

The concentration of the (meth)acrylic acid ester(s) (1) in the collection of monomers allowed to react with the polyester(s) may generally range from as little as about 40 weight percent to as much as about 70 weight percent, based on the total weight of all monomers in the collection of monomers. In various versions, the concentration of the (meth)acrylic acid ester(s) (1) in the collection of monomers allowed to react with the polyester(s) may typically range from as little as about 45 weight percent to as much as about 65 weight percent, based on the total weight of all monomers in the collection of monomers.

Illustrative ethylenically unsaturated mono-functional acids (2) may be represented by the formula CH₂═C(R⁶)—COOH, where R⁶ may be hydrogen or an alkyl radical of 1-6 carbon atoms. Suitable ethylenically unsaturated mono-functional acids (2) may be represented by the formulas R⁷CH═C(COOH)R⁸ , where R⁷ and R⁸ may be hydrogen, an alkyl radical of 1-8 carbon atoms, halogen, a cycloalkyl of 3-7 carbon atoms, or a phenyl radical. The ethylenically unsaturated mono-functional acids (2) may also be suitable alpha, beta-ethylenically unsaturated. carboxylic acids that may be presented by the formula R⁹(COOH)C═C(COOH)R¹⁰, where R⁹ and R¹⁰ may be hydrogen, an alkyl radical of 1-8 carbon atoms, halogen, cycloalkyl of 3-7 carbon atoms, or a phenyl radical.

Some examples of the ethylenically unsaturated, at least mono-functional acid (2) include (meth)acrylic acid; vinylsulfonic acid; crotonic acid; alpha,beta-ethylenically unsaturated carboxylic acids such as maleic acid, 2-methyl maleic acid, fumaric acid, itaconic acid, and 2-methyl itaconic acid; alpha-chloroacrylic acid; alpha-cyanoacrylic acid; alpha-phenylacrylic acid; beta-stearylacrylic acid; sorbic acid; alpha-chlorosorbic acid; angelic acid; cinnamic acid; p-chlorocinnamic acid; citraconic acid; mesaconic acid; aconitic acid; derivatives of these such as any possible anhydride of any of these; and any combination of any of these in any proportion. Furthermore, a salt of any of the listed ethylenically unsaturated, at least mono-functional acids (2) may be used.

The concentration of the ethylenically unsaturated mono-functional acid(s) (2) in the collection of monomers allowed to react with the polyester(s) may generally range from as little as about 5 weight percent to as much as about 40 weight percent, based on the total weight of all monomers in the collection of monomers. In various versions, the concentration of the ethylenically unsaturated mono-functional acid(s) (2) in the collection of monomers allowed to react with the polyester(s) may typically range from as little as about 10 weight percent to as much as about 30 weight percent, based on the total weight of all monomers in the collection of monomers.

Illustrative examples of the optional vinyl compound (3) include any of the vinyl aromatic monomers represented by the structure: Ar—C(R¹¹)═C(R¹²)(R¹³), where R¹¹, R¹², and R¹³ may be hydrogen or an alkyl radical of 1-5 carbon atoms and Ar may be a substituted or unsubstituted aromatic group. Some illustrative examples of suitable vinyl aromatic monomers include styrene, vinyl toluene, halostyrene, isoprene, diallylphthalate, divinylbenzene, butadiene, alpha-methylstyrene, vinyl naphthalene, and any combination of any of these in any proportion. Some other examples of suitable vinyl compounds (3) include (meth)acrylamide, vinyl acetate, vinyl propionate, vinyl butyrate, vinyl stearate, isobutoxymethyl acrylamide, and the like. Styrene may be suitably employed as the optional vinyl compound (3) in many versions, in part due to the relatively low cost of styrene.

The concentration of the optional vinyl compound(s) (3) in the collection of monomers allowed to react with the polyester(s) may generally range up to as much as about 40 weight percent, based on the total weight of all monomers in the collection of monomers. In various versions, the concentration of the optional vinyl compound(s) (3) in the collection of monomers allowed to react with the polyester(s) may typically range from as little as about 10 weight percent to as much as about 30 weight percent, based on the total weight of all monomers in the collection of monomers.

Besides the (meth)acrylic acid ester(s) (1), the ethylenically unsaturated mono- or multi-functional acid(s) (2), and the optional vinyl compound(s) (3), any of a variety of other monomers may optionally be included in the collection of monomers allowed to react with the polyester(s). For example, any hydroxy-functional monomer(s), such as any hydroxyalkyl (meth)acrylate monomer(s) may optionally be included in the collection of monomers allowed to react with the polyester(s). Some examples of such hydroxyalkyl (meth)acrylate monomer(s) include hydroxyethyl acrylate (HEA), hydroxyethyl methacrylate (HEMA), hydroxypropyl acrylate (HPA), hydroxypropyl (meth)acrylate (HPMA), and any of these in any combination and in any proportion. The concentration of the optional hydroxy-functional monomer(s) in the collection of monomers allowed to react with the polyester(s) may generally range up to as much as about 40 weight percent, based on the total weight of all monomers in the collection of monomers.

Also, any unsaturated nitrile(s) represented by the formula: R¹⁴(R¹⁵)C═C(R¹⁶)—CN, where R¹⁴ and R¹⁵ are hydrogen, an alkyl radical of 1-18 carbon atoms, tolyl, benzyl or phenyl; and R¹⁶ is hydrogen or methyl, (such as (meth)acrylonitrile) may optionally be included in the collection of monomers allowed to react with the polyester(s). The concentration of the optional unsaturated nitrile(s) in the collection of monomers allowed to react with the polyester(s) may generally range up to as much as about 40 weight percent, based on the total weight of all monomers in the collection of monomers. Furthermore, any N-alkoxymethyl (meth)acrylamide(s), such as N-isobutoxymethyl (meth)acrylamide, may optionally be included in the collection of monomers allowed to react with the polyester(s).

As noted above, polyester acrylate(s) of the present invention may be formed by reacting the polyester (or any mixture of different polyesters) with the collection of monomers, namely, (1) the (meth)acrylic acid ester(s), (2) the ethylenically unsaturated mono- or multi-functional acid(s), and (3), optionally, the vinyl compound(s). It has been discovered that polyester acrylates formed thereby “mimic” or exceed the properties of traditional “1007-type”; “1009-type”; and “9-A-9-type” epoxy resins, without containing or liberating BPA or aromatic glycidyl ether compounds (e.g., BADGE, BFDGE and epoxy novalacs).

As noted above, after formation, the polyester(s) may be dissolved in additional organic solvent in preparation for formation of polyester acrylate(s) via reaction with the collection of monomers. The solution of the polyester(s) and the collection of monomers may be combined to form a mixture. Then, the polyester(s) and monomers present in the collection of monomers (i.e., polymerizable components of the mixture) may be subjected to in-situ polymerization in the presence of a free radical-generating initiator to form a reaction mixture that contains polyester acrylate(s). The weight ratio of the polyester(s) to the acrylic polymer(s) in the polyester acrylate(s) may generally range from about 90:10 to about 50:50, more typically may range from about 80:20 to about 60:40, and, in some versions often ranges from about 65:35 to about 75:25.

The free radical-initiated polymerization may be carried out at temperatures between about 80° C. and about 160° C. The polyester acrylate(s) may then be at least partially neutralized with a base and thereafter dispersed in water. The organic solvent remaining in the reaction mixture with the polyester acrylate(s) may be partially removed by an evaporative process, such as distillation, optionally under reduced pressure, after dispersal of the at least partially neutralized polyester acrylate(s) in water.

Some exemplary free radical-generating initiators for use in forming the polyester acrylate(s) include di-tert.-butyl peroxide, dicumyl peroxide, dibenzoyl peroxide, dilauroyl peroxide, cumol hydroperoxide, tert.-butylhydroperoxide, tert.-butyl perbenzoate, tert.-butyl perpivalate, tert.-butyl per-3,5,5-trimethylhexanoate, tert.-butyl per-2-ethylhexanoate, di-2-ethylhexyl peroxydicarbonate, dicyclohexyl peroxydicarbonate, 1,1-bis-(tert.-butylperoxy)-3,5,5-trimethylcyclohexane, 1,1-bis(tert.-butylperoxy) cyclohexane, cyclohexanone peroxide, methylisobutylketone peroxide, 2,2′-azo-bis-(2,4-dimethylvaleronitrile), 2,2′-azo-bis-(2-methylbutyronitrile), 1,1-azo-bis-cyclohexanecarbonitrile or azo-bis-isobutyronitrile. VAZO® 67 Free Radical Initiator available from E. I. du Pont de Nemours and Company of Wilnington, Del. is an example of a suitable azo-type free radical-generating initiator. TRIGONOX® C Free Radical Initiator, an organic peroxyester (specifically tert-butyl peroxybenzoate) that is available from Akzo Nobel Polymer Chemicals LLC of Chicago, Ill., is another example of a suitable free radical-generating initiator.

For purposes of enhancing the stability of the aqueous dispersions of the polyester acrylates, groups capable of forming anions, preferably carboxyl groups, may be, and preferably are, maximized in polyester acrylates produced in accordance with the present invention. These groups capable of forming anions may be introduced via the polyester component as well as via the (meth)acrylic acid ester(s) (1), and may also be introduced via both of these components. However, the groups capable of forming anions preferred are preferably introduced via the (meth)acrylic acid ester(s) (1).

The acid number (“AN”) of the polyester acrylate(s) produced according to the present invention may generally range from as low as about 5 mg KOH/gm of the polyester acrylate(s) to as high as about 100 mg KOH/gm of the polyester acrylate(s), and in some embodiments more typically range from as low as about 20 mg KOH/gm of the polyester acrylate(s) to as high as about 70 mg KOH/gm of the polyester acrylate(s). Suitable polyester acrylate(s) will generally have a number average molecular weight (Mₙ) ranging from as low as about 2,500 to as high as about 20,000; in some embodiments, the Mₙ of the polyester acrylate(s) may range from as low as about 3,000 to as high as about 16,000. In other embodiments, the Mₙ of the polyester acrylate(s) may generally range from as low as about 4,000 to as high as about 12,000, and may sometimes range from as low as about 3,000 to as high as about 5,000.

As present in the aqueous dispersions of the present invention, the particles of polyester acrylate may generally have any diameter and particle profile conducive to maintaining a uniform, homogenous blend of the polyester acrylate particles in the aqueous dispersions and coating compositions of the present invention. In many of the aqueous dispersions of the present invention, the collective volume of all polyester acrylate particles with diameters of less than about 5 μm (micrometers) will be at least about 90% of the total volume of all polyester acrylate particles present in the aqueous dispersions of the present invention. Indeed, in various aqueous dispersions of the present invention, the collective volume of all polyester acrylate particles with diameters of less than about 1 μm will be at least about 90% of the total volume of all polyester acrylate particles present in these various aqueous dispersions of the present invention.

When polyunsaturated monomers are included in the collection of monomers to be reacted with the polyester(s), there is a potential for gelation. Therefore, the reaction conditions for formation of the polyester acrylate(s) may be adjusted to accommodate the types and amounts of such polyunsaturated monomers and avoid gelation during formation of the polyester acrylate(s). If desired or required, it may make sense to concomitantly use so-called modifiers such as, e.g., dodecylmercaptane or mercaptoethanol that are described in EP-A-0 158 161.

After formation of the polyester acrylate(s), the polyester acrylate(s) is incorporated into the aqueous dispersion of the present invention. The organic solvent remaining in the reaction mixture with the polyester acrylate(s) may optionally be partially removed by an evaporative process, such as distillation, optionally under reduced pressure, after dispersal of the at least partially neutralized polyester acrylate(s) in water.

Prior to forming the aqueous dispersion, groups present in the polyester acrylate(s) that are capable of forming anions are at least partially neutralized using a base. The neutralization may be effected by adding base to the reaction mixture prior to inversion. The pH of the aqueous dispersion of polyester acrylate(s) after inversion may generally range from as low as about 7 standard pH units to as high as about 10 standard pH units, and, more typically may range from as low as about 7.3 standard pH units to as high as about 8.5 standard pH units. The reaction of the mixture of monomers in-situ with the polyester(s) is believed to entail formation of acrylic polymer(s) accompanied by grafting (or copolymerization) of the acrylic polymer(s) to the polyester(s). The polyester(s) are hydrophobic in nature. The neutralization of the polyester acrylate(s) is thought to convert acid functional groups on the acrylic polymer portion of the polyester acrylate(s) into salt forms of the acid functional groups that are strongly hydrophilic. The strongly hydrophilic nature of the acrylic polymer portion, after at least partial neutralization, allows the acrylic polymer portion to support dispersion of the polyester acrylate(s), including the hydrophobic polyester portion of the polyester acrylate(s), in water.

The base used to at least partially neutralize the polyester acrylate(s) may, for example, be ammonia or any volatile primary, secondary and/or tertiary organic amine(s). One example of a suitable volatile primary organic amine is ethylamine. Some examples of suitable volatile secondary organic amines are dimethylamine, diethanolamine, morpholine, piperidine and any combination of any of these in any proportion.

The base used to at least partially neutralize the polyester acrylate(s) preferably includes at least one volatile tertiary organic amine. Some exemplary volatile tertiary organic amines may be represented by formula R¹⁷R¹⁸R¹⁹N, wherein R¹⁷, R¹⁸, and R¹⁹ are independently either substituted or unsubstituted monovalent alkyl groups that may generally each contain 1 to 8 carbon atoms, and in some versions may each contain 1 to 4 carbon atoms. Some examples of suitable volatile tertiary organic amines are trimethyl amine, dimethyl ethanol amine (also known as dimethyl amino ethanol), methyl diethanol amine, triethanolamine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine, and any of these in any combination in any proportion. One exemplary volatile tertiary organic amine, dimethyl ethanol amine, is available as the AMIETOL® M21 product from Cytec Industries Inc. of Stamford, Conn.

The base is beneficially added to the reaction mixture via a diluted aqueous solution to more evenly distribute neutralization of polyester acrylate(s) throughout the reaction mixture. The amount of base, such as volatile tertiary organic amine, employed in the neutralization of the polyester acrylate(s) may be adjusted depending on a number of different factors. As a minimum, an amount of base sufficient to maintain the polyester acrylate(s) in stable suspension in the subsequent aqueous dispersion is desirable. This amount of the base used in turn may depend on other factors, such as the molecular weight of the polyester acrylate(s); the nature, number, and interrelationship of functional groups on the polyester acrylate(s); and the concentration of the polyester acrylate(s) in the aqueous dispersion. Generally, the polyester acrylate(s) (i.e. the carboxyl groups of the polyester acrylate(s)) may be at least partially neutralized with about 0.3 to 1.5 equivalents of the base.

The aqueous dispersions of this invention may generally be prepared in a few different ways. The components of the aqueous dispersion of the present invention may include at least the at least partially neutralized polyester acrylate(s), organic solvent(s), and accompanying water and base from the neutralization procedure, though the organic solvent(s) may be removed if desired. Additional water for the inversion, especially deionized water, may be added to the at least partially neutralized solution of polyester acrylate(s). As an alternative, the at least partially neutralized solution of polyester acrylate(s) may be added to water in a reverse inversion process. The at least partially neutralized solution of polyester acrylate(s) may be inverted at any appropriate inversion temperature, such as at a temperature ranging from about 60° C. to about 90° C.

Mixing of the components during the inversion step completes preparation of the aqueous dispersion. The components may generally be mixed using any conventional mixing equipment adequate to uniformly mix the components without shearing or degrading the at least partially neutralized polyester acrylate(s). The components may generally be mixed at any temperature, such as room temperature, though elevated temperatures ranging from about 60° C. to about 90° C. may be used, so long as the selected temperature does not deleteriously affect any components of the aqueous dispersion.

Coating compositions suitable for coating interior surfaces of metal containers in food and beverage contact applications may either consist of or include any aqueous dispersion of polyester acrylate(s) of the present invention. In many applications, the aqueous dispersions of polyester acrylate(s) are combined with one or more additional components to form coating compositions with desired properties for particular uses. In coating compositions that comprise the aqueous dispersion of polyester acrylate(s) along with one or more additional components, the coating composition exists and functions as an aqueous dispersion with the polyester acrylate and any other solid components of the coating composition remaining dispersed within the liquid phase of the coating composition. The components of the coating composition may generally be mixed to form the coating composition using any conventional mixing equipment adequate to uniformly mix the components without shearing or degrading the polyester acrylate(s). The components may generally be mixed at any temperature, such as room temperature, though elevated temperatures ranging from about 60° C. to about 90° C. may be used, so long as the selected temperature does not deleteriously affect any components of the coating composition.

The concentration of the at least partially neutralized polyester acrylate(s) in the coating composition dispersion will generally range from as little as about 20 weight percent to as much as about 55 weight percent, and more typically in versions for some applications will range from as little as about 25 weight percent to as much as about 35 weight percent, based on the total weight of the coating composition. Also, the concentration of total solids in the coating composition, as determined using the Total Solids Determination Procedure provided in the Property Analysis And Characterization Procedure section of this document, will generally range from as little as about 20 weight percent to as much as about 55 weight percent, and more typically in versions for some applications will range from as little as about 25 weight percent to as much as about 35 weight percent, based on the total weight of the coating composition. In some embodiments, the coating compositions that comprise the aqueous dispersions of polyester acrylate(s) contain as little as about 24 weight percent solids and as much as about 30 weight percent solids, based on the total weight of the coating composition. For spray applications, the viscosity of the coating composition at a temperature of about 25° C. may generally range from as little as about 22 sec to as much as about 26 sec, as determined in accordance with Viscosity Determination Procedure #2 recited in the Property Analysis And Characterization Procedure section of this application using a Ford #4 cup.

Organic solvent(s) may permissibly be incorporated along with the aqueous dispersion of polyester acrylate(s) in the coating composition and are typically incorporated for particular applications of the coating composition. The organic solvent(s) may have any solubility in water and therefore may be water-miscible organic solvent(s), water-immiscible organic solvent(s), and any combination of these. The decision to include organic solvent(s) in the coating composition or exclude organic solvent(s) from the coating composition depends both on the application and desired application performance of the coating composition and upon the chemistry of the polyester acrylate(s) incorporated in the coating composition and is within the purview of those of ordinary skill in the art of coatings for metallic packaging of beverages and foodstuffs. Some examples of suitable water-miscible organic solvents include water-miscible glycol ethers, such as butylglycol and butyldiglycol. The organic solvent(s) selected for use in the coating composition will desirably be compatible with maintaining the low VOC content achievable for aqueous dispersions and coating compositions produced in accordance with the present invention.

The concentration of water in the coating composition that is based on the aqueous dispersion of polyester acrylate(s) may, subject to requirements for a particular application of the coating composition, generally range from as low as about 30 weight percent up to 100 weight percent, based on the total weight of the volatile portion of the coating composition. In various versions of the aqueous dispersion, the concentration of water in the coating composition will range from as low as about 70 weight percent up to 100 weight percent, based on the total weight of the volatile portion of the coating composition.

The concentration of organic solvent in the coating composition may, subject to requirements for a particular application of the coating composition, generally range from 0 weight percent up to as high as about 70 weight percent, based on the total weight of the volatile portion of the coating composition. In various versions of the coating composition, the concentration of organic solvent in the coating composition will range from 0 weight percent up to as high as about 30 weight percent, based on the total weight of the volatile portion of the coating composition.

The concentration of water in the coating composition and the concentration of organic solvent in the coating composition may fall outside the values stated above if appropriate or necessary for a particular application of the coating composition. The concentration of water in the coating composition and the concentration of organic solvent in the coating composition are each expressed in weight percent of the volatile portion of the coating composition and are therefore based only on the total weight of the volatile portion of the coating composition.

The coating compositions that consist of or comprise aqueous dispersions of polyester acrylate(s) produced in accordance with the present invention are stable and therefore generally exhibit stable and uniform dispersal of the polyester acrylates and other optional solid particulate components within the liquid phase even after longer storage times of several days or even weeks. Stability, in the context of the coating compositions of the present invention, refers to the tendency of solid components present in the coating composition (aqueous dispersion) to remain uniformly and homogeneously afloat and dispersed in the coating composition (aqueous dispersion) without particle agglomeration and without any significant viscosity change over time. Beneficially, such stability of the coating compositions that consist of or comprise aqueous dispersions of polyester acrylate(s) produced in accordance with the present invention has been observed, with only negligible, if any, solid particle separation (settling) or agglomeration and only negligible, if any, viscosity changes over periods of days and even weeks.

Desirably, the coating compositions produced in accordance with the present invention exhibits settling of 0.1 weight percent, or less, of the solid phase components (as particles) originally included in the coating composition, after a resting period of one week following preparation of the coating composition. Likewise, coating produced in accordance with the present invention exhibits one percent, or less, numerical change in viscosity, after a resting period of one week following preparation of the coating composition.

It has been discovered that the aqueous dispersions of polyester acrylate(s) and the coating compositions of the present invention that consist of or comprise aqueous dispersions of polyester acrylate(s) produced in accordance with the present invention may be formulated to optionally include one or more crosslinking agents which, upon application of activation energy at an appropriate rate, are cross-linked with the at least partially neutralized polyester acrylate(s) present in the coating compositions. Selection of any particular optional crosslinking agent(s) typically depends on the particular application of the coating composition. Any of the well known hydroxyl-reactive curing resins may be used as the optional crosslinking agent in any of the coating compositions. For example, phenoplast and/or aminoplast curing agents may be incorporated in the coating compositions.

Phenoplast resins include the condensation products of aldehydes, such as formaldehyde and acetaldehyde, with phenols. Various phenols may be employed, such as phenol, cresol, p-phenylphenol, p-tert-butylphenol, p-tert-amylphenol, cyclopentylphenol, and combinations of these. One suitable phenoplast resin is available as part of the VARCUM® 2227 B55 phenolic resin solution that may be obtained from Reichhold Corporation of Durham, N.C., USA. VARCUM® 2227 B55 phenolic resin solution contains 55 weight percent phenolic resin, based on the total weight of the VARCUM® 2227 B55 phenolic resin solution. Aminoplast resins are the condensation products of aldehydes, such as formaldehyde, acetaldehyde, crotonaldehyde, and benzaldehyde, with amino or amido group-containing substances, such as urea, melamine, benzoguanamine, and combinations of these.

Examples of suitable crosslinking agents include, without limitation, benzoguanamine-formaldehyde resins, melamine-formaldehyde resins, esterified melamine-formaldehyde resins, urea-formadehyde resins, and any combination of these in any proportion. In some versions, the crosslinking agent employed comprises a melamine-formaldehyde resin. One specific example of a particularly useful crosslinking agent is the fully alkylated melamine-formaldehyde resin commercially available from Cytec Industries, Inc. of Stamford, Conn. under the CYMEL 303 trade name. Some examples of other generally suitable crosslinking agents are the blocked or non-blocked aliphatic, cycloaliphatic, or aromatic di-, tri- or polyvalent isocyanates, such as hexamethylene diisocyanate, cyclohexyl-1,4-diisocyanate, and the like.

The concentration of the crosslinking agent optionally employed in any coating composition may depend on a number of different factors, such as the type of crosslinking agent, the time and temperature of the cure, and the molecular weight of the polyester acrylate(s) in the coating composition. The crosslinking agent may generally be present in the coating composition in an amount ranging. from as little as about 5 weight percent to as much as about 50 weight percent. In some versions, the crosslinking agent may be present in the coating composition in an amount ranging from as little as about 10 weight percent to as much as about 40 weight percent, and, more typically, may be present in the coating composition in an amount ranging from as little as about 15 weight percent to as much as about 30 weight percent. These weight percentages of the crosslinking agent are based on the total weight of the resin solids, such as the total weight of the crosslinking agent(s) and the total weight of the polyester acrylate(s), in the composition.

The coating compositions of the present invention may also include other optional ingredients that do not adversely affect the coating compositions or cured coatings resulting from application of the compositions on substrates and subsequent curing of the applied coating compositions. Such optional ingredients are typically included in the coating compositions to enhance esthetics of the cured coatings; to facilitate manufacturing, processing, handling, and application of the coating compositions; and/or to further improve a particular functional property of the coating compositions or the cured coatings that are based on the coating compositions.

Such optional ingredients of the coating compositions include, for example, catalyst(s), dye(s), pigment(s), toner(s), extender(s), filler(s), lubricant(s), anti-corrosion agent(s), flow control agent(s), defoaming agent(s), leveling agent(s), thixotropic agent(s), dispersing agent(s), antioxidant(s), adhesion promoter(s), light stabilizer(s), and mixtures thereof Each optional ingredient may be included in the coating compositions at a concentration effective to serve the intended purpose of the optional ingredient, but not in such an amount that may adversely or deleteriously affect a desired property or a desired characteristic of the coating compositions or the cured coatings resulting from the coating compositions.

One optional ingredient of the coating compositions is a catalyst to increase the rate at which applied coatings of the coating compositions cure. The catalyst may generally be present at a concentration ranging from 0 weight percent to as much as about 1 weight percent. For some versions, the catalyst may typically be present at a concentration ranging from as little as about 0.05 weight percent to as much as about 1 weight percent, and more typically ranging from as little as about 0.1 weight percent to as much as about 0.5 weight percent. These weight percentages are based on the total weight of the resin solids, such as the total weight of the crosslinking agent(s) and the total weight of the polyester acrylate(s), in the coating compositions. Examples of some suitable catalysts, include, but are not limited to, strong acids {e.g., dodecylbenzene sulphonic acid (ddbsa, available as CYCAT 600 catalyst from Cytec Industries, Inc. of Stamford, Conn.), msa, para-toluenesulphonic acid (ptsa), dinonylnaphthalene disulphonic acid (dnndsa), and triflic acid}; quaternary ammonium compounds; phosphorous compounds; and tin and zinc compounds, like a tetraalkyl ammonium halide, a tetraalkyl or tetraaryl phosphonium iodide or acetate, tin octoate, zinc octoate, or triphenylphosphine; and similar catalysts known to persons skilled in the art.

Another useful optional ingredient for the coating composition is a pigment, like titanium dioxide. A pigment, like titanium dioxide, is optionally present in the coating composition in an amount ranging up to about 50 weight percent, based on the total weight of the all solids present in the coating composition.

The coating compositions that consist of or comprise the aqueous dispersions of polyester acrylate(s) of the present invention are particularly well adapted for use as a coating for metal food and beverage packaging containers (e.g., two-piece cans, three-piece cans, etc.). Two-piece cans are manufactured by joining a can body with a can end. The can body is typically produced by a drawing process wherein metal sheet is cut into substantially circular blanks, the blanks are then shaped with a die to form a cup, and the cup is then drawn into a container body, such as the can body. Can bodies that are formed by drawing have an end portion and a body (or shell) portion, which is integral with and extends away from the end portion. The can end that is joined with the can body to produce a closed container or closed can may be formed by any conventional process, such as a stamping process or a drawing process. As an alternative to simply being drawn, can bodies may also be formed by a drawing and ironing process wherein the cup formed in preparation for drawing may drawn and ironed into a container body by forcing the cup through a series of dies having progressively smaller diameters.

Coatings based on the coating compositions of the present invention are suitable for use in food contact and beverage contact situations and may be used on interior surfaces of such cans. Any metal that may be coated with coating compositions of the present invention may be used in metal food and beverage packaging containers (or components thereof), though aluminum and steel are some of the most commonly used metals in metal food and beverage packaging containers (or components thereof).

As described in previous sections, the coating compositions of the present invention are demonstrated to possess a high degree of utility as a spray-applied, liquid coating for interior portions of two-piece drawn tinplate food cans and for interior portions of two-piece drawn and ironed tinplate food cans (hereinafter “tinplate D&I cans”). When used as a spray coating, the viscosity and surface tension of the coating compositions may be adjusted for optimal spray performance by, for example, incorporating appropriate thixotropic or rheology agents in the coating compositions, adjusting the concentration of water in the coating compositions, adjusting the concentration and type of hydrophilic organic solvent(s) and/or base incorporated in the coating compositions, and/or by adjusting the concentration, type, and/or the molecular weight of the polyester acrylate(s) included in the coating compositions.

Besides uses as a spray-applied, liquid coating for interior portions of two-piece drawn tinplate food cans and two-piece drawn and ironed tinplate food cans, the coating compositions of the present invention also offer utility in other food contact and beverage contact packaging applications. These additional applications include, but are not limited to coil coating and sheet coating applications for portions of food and beverage packaging containers that may be or will be in contact with the food or beverage.

A coil coating is described as the coating of a continuous coil composed of a metal (e.g., steel or aluminum). Once coated, the coating coil is subjected to a short thermal, and/or ultraviolet and/or electromagnetic curing cycle, which lead to the drying and curing of the coating. Coil coatings provide coated steel and/or aluminum substrates that may be fabricated into formed articles, such as 2-piece drawn food cans, 3-piece food cans, food can ends, drawn and ironed cans, beverage can ends, and the like.

Sheet coating is described as the coating of separate steel or aluminum pieces that have been pre-cut into square or rectangular “sheets.” Typical dimensions of these sheets are approximately one square meter. Once coated, the coating on each sheet is cured. Once dried and cured, the sheets of the coated substrate are collected and prepared for subsequent fabrication. Coil coatings provide coated steel and/or aluminum substrates that may be successfully fabricated into formed articles such as 2-piece drawn food cans, 3-piece food cans, food can ends, drawn and ironed cans, beverage can ends, and the like.

The coating compositions of the present invention may be applied to interior metal surfaces of any food and beverage packaging container by any conventional application technique, such as spraying. For example, where a food and beverage packaging container includes a body portion and an attached end portion along with an open end, the coating compositions may be coated onto all interior surfaces of the body portion and the attached end portion via any appropriate application technique, such as a spraying technique. In one aspect, the coating compositions according to the invention are distinguished over conventional coating compositions containing organic components by the low content of volatile organic solvents along with the high solids content and low viscosity when employed in spraying applications. Furthermore, the coating compositions of the present invention may be applied to any metal surface of any packaging container material that will be formed into, or incorporated in, any food and beverage packaging container by any conventional application technique, such as spraying, brushing, knife-coating, or immersion. Other commercial methods for applying and curing applications of the coating compositions of the present invention on interior surfaces of food or beverage cans, for example, electrocoating, extrusion coating, laminating, powder coating, and the like, are also envisioned.

The coating compositions according to the invention may be applied as coatings to these interior metal surfaces, metal surfaces of any packaging container material, and any metal surface of any packaging container component to have any desired or conventional thickness upon curing of the coating of the coating composition. Once the desired amount of the coating of a particular coating composition of the present invention is applied to these interior metal surfaces, metal surfaces of any packaging container material, and any metal surface of any packaging container component, the coated metal surface may be passed through a thermal and/or ultraviolet and/or electromagnetic curing oven to dry and cure the applied coating. The residence time of the coated metal surface within the curing oven may typically be on the order of about one minute to about five minutes. The curing temperature within this oven may typically range from about 150° C. to about 250° C. This drying and curing solidifies and strengthens the coating and yields a cured coating that is durable and resilient. The cured coating derived from any coating composition of the present invention constitutes a protective liner that prevents food and beverages held within foods and beverage packaging containers from contact with interior surfaces of the food and beverage packaging containers, and vice versa.

The coating compositions that consist of or comprise aqueous dispersions of polyester acrylate(s) according to the invention are particularly suitable for use as coatings that form liners within any food and beverage packaging container that may be or will be in contact with food or beverages. Indeed, cured coatings of the coating compositions of the present invention “mimic” or exceed the properties of cured coatings of “1007-type”; “1009-type”; and “9-A-9-type” epoxy resins traditionally employed in food contact and beverage contact applications, but without containing or liberating BPA or aromatic glycidyl ether compounds (e.g., BADGE, BFDGE and epoxy novalacs).

Also, foods and beverages packaged and stored in food or beverage containers containing cured internal coatings of the coating compositions of the present invention generally do not deleteriously affect the cured internal coatings, despite the corrosive nature of some of the packaged foods and beverages. For example, cured internal coatings of the coating compositions are predominantly or entirely free of blistering and delamination from interior surfaces of food and beverage cans filled with different foods and beverages. Furthermore, cured internal coatings of the coating compositions are predominantly or entirely free of damaging effects potentially imparted by retorting operations some foods or beverages experience after packaging in food or beverage containers containing cured internal coatings of the coating compositions.

The bottom (end portion) of many 2-piece cans is structured with a peripheral depression or recess that surrounds a high crowned center section. The peripheral depression or recess of the bottom or end portion is attached (integrally in drawn or drawn and ironed cans) to an end of the body (or shell) portion of the 2-piece can. The peripheral depression or recess of the bottom or end portion and the high crowned center section of the bottom or end portion are integrally interconnected by what is commonly referred to as a “reverse” wall section. Successful spray application of a coating of adequate thickness and uniformity to this reverse wall section of the 2-piece cans is thought to depend to at least a substantial extent on the ability of the material being applied as the coating to bounce or rebound off the lower inside wall of the body (or shell) portion and onto the reverse wall section. Beneficially, various embodiments of the coating compositions of the present invention are well suited to spray applications that apply adequate and even substantially uniform coatings of the coating compositions to the reverse wall section of 2-piece cans.

Additionally, the coating compositions of the present invention that consist of or comprise aqueous dispersions of the polyester acrylate(s) are well suited to high-speed applications on internal container surfaces, while still providing suitable performance properties as the cured internal surface coating. For example, the viscosity, solids content, and solids uniformity within the aqueous dispersions (coating compositions), and the interaction of these variables, may be adjusted for consistent and efficient spraying operations with minimal or any spraying equipment downtime. Furthermore, these variables support application of a consistent and uniform coating of the coating compositions to all internal surfaces of food or beverage cans.

Finally, when cured coatings of the coating compositions are subjected to mechanical stress, such as stretching and other forces that might be expected to tear the coating or separate the coating from internal surfaces of the food or beverage container, the cured coatings nevertheless are sufficiently flexible, extensible, ductile, and adhesive to withstand any such tearing, fracture, de-lamination, or separation. These observations hold true during formation, working, and assembly of components or portions of food or beverage cans with internal surfaces containing cured coatings of the coating compositions.

From the foregoing, it will be appreciated that the coating compositions of the present invention that consist of or comprise aqueous dispersions of the polyester acrylate(s) are particularly adapted to efficient spray application of a uniform and complete coating of the coating compositions to all internal surfaces of food or beverage cans. Additionally, cured coatings of the coating compositions “mimic” or exceed the properties of many cured coatings traditionally employed in food contact and beverage contact applications, but without containing or liberating BPA or aromatic glycidyl ether compounds (e.g., BADGE, BFDGE and epoxy novalacs). Furthermore, cured coatings of the coating compositions in food and beverage cans are resistant to degradation both by foods or beverages contained in the cans and by processing conditions of packaged foods or beverages. Finally, cured coatings of the coating compositions are sufficiently flexible, extensible, ductile, and adhesive to withstand any tearing, fracture, delamination, or separation during formation, working and assembly of coated components or portions of food or beverage cans.

Besides being applied directly onto metal surfaces, the coating compositions of the present invention may also be applied “wet-on-wet” onto another aqueous or non-aqueous base coating. The wet-on-wet application does not exclude the possibility the base coating may be allowed to become touch dry before the coating composition is applied onto the base coating; both coatings typically may be commonly cured or baked, respectively (e.g. at from about 150° C. to about 250° C. for from about one to about fifteen minutes).

In some embodiments, the coating compositions of the present invention that consist of or comprise aqueous dispersions of the polyester acrylate(s) contain less than about 3 pounds of VOC (volatile organic compounds) per gallon (360 grams VOC per liter) of the coating composition. Details about how to determine the weight of VOC per unit volume of the coating composition are provided under the VOC Content Determination Procedure in the Property Analysis And Characterization Procedure section of this document.

As another approach to considering the low VOC content achievable via the present invention, the VOC content of the coating compositions of the present invention will typically range from a maximum of about 1,000 milligrams of VOC per kilogram of the non-volatile matter portion of the coating composition down to as low as 0 grams of VOC per kilogram of the non-volatile matter portion of the coating composition. In numerous embodiments, the VOC content of the coating composition ranges from a maximum of about 600 milligrams of VOC per kilogram of the non-volatile matter portion of the coating composition down to as low as 0 grams of VOC per kilogram of the non-volatile matter portion of the coating composition. In some of these embodiments, the VOC content of the coating composition ranges from as little as about 400 milligrams of VOC per kilogram of the non-volatile matter portion of the coating composition down to as low as 0 grams of VOC per kilogram of the non-volatile matter portion of the coating composition. Details about how to determine the weight of VOC per unit weight of the non-volatile matter portion of the coating composition are provided under the VOC Content Determination Procedure in the Property Analysis And Characterization Procedure section of this document As used herein, the term “wet” foodstuff means a foodstuff that includes free liquid, such as water. Also, as used herein, the term “foodstuff” means a substance that can be used or prepared for use as food, for either humans or animals. Additionally, as used herein, the term “beverage” means any one of various liquids for drinking, by either humans or animals.

Packaging containers that include the liners of the present invention based on the coating compositions that consist of or comprise aqueous dispersions of polyester acrylates of the present invention may be filled with various beverages and foodstuffs, including wet foodstuffs. Interior surfaces of the packaging containers define a space, and the various beverages and foodstuffs may be placed within this space. The liner is in contact with the interior surfaces of the packaging container and the beverages or foodstuffs, such as wet foodstuffs, are in contact with the liner. Thereby, the liner separates the beverages or foodstuffs from interior surfaces of the packaging container. The packaging containers may also include a container end portion with an interior surface and a container body portion that collectively enclose the space within the container. The liner is attached to and covers the interior surface of the container end portion separates the beverages or foodstuffs from interior surfaces of the packaging container to further prevent contact between the beverages or foodstuffs and interior surfaces of the packaging container.

The beverages and any wet portions of the foodstuffs placed in packaging containers bearing the liner of the present invention may have any salt concentration. Also, the beverages and any wet portions of the foodstuffs placed in packaging containers bearing the liner of the present invention may have any pH. Beverages and the wet portions of various foodstuffs that have an pH of <7 standard pH units are acidic. When a foodstuff is referred to herein as being acidic, this is to be understood as meaning the wet portion of the foodstuff has an acidic pH. As used herein, with reference to beverages and foodstuffs, the term “slightly acidic” means the beverage or foodstuff has a pH <7 and >4.5, the term “moderately acidic” means the beverage or foodstuff has a pH of 3.7 to 4.5, and the term “highly acidic” means the beverage or foodstuff has a pH <3.7. The beverages and any wet portions of the foodstuffs placed in packaging containers bearing the liner of the present invention may have have any pH and therefore may be slightly acidic, moderately acidic, or highly acidic.

The term “potentially corrosive,” as used herein with reference to beverages and foodstuffs, means a beverages and foodstuffs with a salt content or a pH (typically an acidic pH, but could be a basic pH {>7}) that may cause corrosion of the metal present in a packaging container when in contact with the metal of the packaging container. Various approaches to determining if corrosion exists and characterizing the extent of any corrosion are provided below in the Property Analysis And Characterization Procedure section of this document. Liners attached to and covering interior surfaces of packaging containers (also referred to herein as “internal liners”) and derived from coating compositions that consist of or comprise aqueous dispersions of polyester acrylates in accordance with the present invention substantially eliminate, essentially eliminate, and even eliminate corrosion of metal present in the metal of the packaging containers, despite longer term storage of acidic, and even highly acidic, beverages and foodstuffs and salt-containing beverages and foodstuffs in the packaging containers. This elimination of corrosion maintains the integrity of the packaging containers and thereby helps prevent leakage of the beverages and foodstuffs from the packaging containers, helps maintain the shelf life of the beverages and foodstuffs held in the packaging containers, and prevents the beverages and foodstuffs from picking up off-flavors, such as metallic flavors, from the packaging containers.

Some non-exhaustive examples of acidic beverages that may be beneficially stored in packaging containing internal liners of the present invention include beer; wine; soft drinks; fruit drinks, such as orange juice; vegetable drinks, such as tomato juice; dairy beverages, such as buttermilk; and coffee. Some non-exhaustive examples of acidic beverages that may be beneficially stored in packaging containing internal liners of the present invention include vegetables, such as tomatoes, sauerkraut, pickles, and hot peppers; fruits, such as apples, blueberries, peaches, oranges, grapefruit, and grapes; various foods containing, preserved in, or pickled in vinegar; condiments, such as ketchup and vinegar; dairy foods, such as yogurt; soups, such as tomato; sauces, such as tomato sauce and many barbeque sauces; and various salad dressings, particularly those containing vinegar.

### Property Analysis and Characterization Procedure

Various properties and characteristics of the constructions cited herein may be evaluated by various testing procedures as described below:

Coating Uniformity/Metal Exposure Evaluation:

This test method determines the amount of the inside surface of the can that has not been effectively coated by the sprayed coating. This determination is made using an electrically conductive solution (1% NaCl in deionized water). The coated can is filled with this conductive solution. An electrical probe is attached in contact to the outside of the can (uncoated, electrically conducting) and a second probe is immersed in the salt solution in the middle of the inside of the can. If any uncoated metal is present on the inside of the can, then a current is passed between these two probes and registers as a value on an LED display. The LED displays the conveyed current in milliamps, or more commonly referred to as “mAs.” This conveyed current observed during this Coating Uniformity/Metal Exposure test procedure is also referred to herein as the “Enamel Rating.” The current that passes between the two probes is directly proportional to the amount of metal that has not been effectively covered with coating. Achieving 100% coating coverage on the inside of the can would result in an LED reading of 0.0 mAs. However, commercially acceptable metal exposure values for food and beverage cans are typically less than about 3.0 mAs on average.

Coating Spreadability/Wetting Evaluation:

This test is essentially a visual assessment of the ability of a coating to effectively “wet” or spread evenly across the inside surface of the sprayed can. It is desired for the sprayed coating to spread evenly without visual defects such as eyeholes, creeping, crawling or others, which may result in a higher metal exposure value or other visually objectionable phenomena. A rating of excellent is believed to indicate that a can is of commercially acceptable quality. The rating scale is verbal and is defined as follows: Excellent: No visual defects; Good: Very few, minimal defects; Fair: Few significant defects; Poor: Frequent occurrence of significant defects.

Blistering Evaluation:

This test is essentially a visual inspection of the tendency of a coating to “blister” or form undesirable air bubbles in specific areas inside a spray-coated can. It is commercially undesirable for the coating on the inside of a can to possess visible blistering. As such a blister rating of “Excellent” indicates cans that are believed to be of commercial quality. The rating scale is verbal and is defined as follows: Excellent: No visual blistering; Good: Very few, small blisters; Fair: Frequent occurrence of small blisters; Poor: Frequent occurrence of large blisters.

Cured Film Performance Evaluation:

There are a wide variety of food products that are “packed” commercially within coated, tinplate D&I cans. For coating research and development purposes, several coating “screening tests” have been developed to help predict whether or not a coating possesses the required staining, adhesion and corrosion performance to function acceptably as an interior lacquer for commercially prepared and packed D&I tinplate cans. Of particular interest is the performance of a coating under food sterilization cycles, more commonly referred to as “food retorts.” Food retort is a thermal sterilization of the packed can that is conducted in superheated and pressurized steam and/or water.

Typical commercial sterilization retorts pass packed food cans through superheated steam or water for a time period ranging from about 10 minutes up to several (1-3) hours, depending on factors such as the can size and the food product of interest. The temperature of the steam or water is approximately 121° C. It is under these retort conditions that some interior can coatings may begin to fail in coating performances such as stain resistance, adhesion, or corrosion resistance. The function of the interior coating is to protect interior surfaces of the can from the packed product (corrosion, staining resistance) as well as to protect the packed product from the can (metal exposure, adhesion). It is commercially undesirable for the internal coating of D&I cans to show dramatic failures in these areas under packing, sterilization or storage conditions. As such, a testing protocol has been effectively developed to predict the commercial performance of any prospective new D&I can interiors.

Of particular interest is the “headspace” (or “dome”) area of the can where the performance requirements tend to be the most difficult. The headspace is the small area at the top of the can (typically 0.5-1.0 cm) in which there is no food product. The headspace is left in each can to allow for expansion of the product during retorting, without explosion of the can by the pressure of its contents. Additional evaluations following retort are sometimes made at the dome and bead sections of the cans.

In order to conduct this evaluation, a sufficient number of test cans are prepared using the coating variables to be tested. Once the cans are completely coated with the coatings of interest, several food product test media are selected to conduct the food product resistance testing. For the gold variables, the products selected are representative of a long list of products that are typically commercially packed in gold D&I cans. Once the actual food products are selected, they are filled within the can body at the temperatures which are employed commercially. One should consult a commercial canning guide for more details or reference. Typically, each can is filled to within about 1.25 cm (headspace) to allow for expansion of the product during retort. Once filled, each can is appropriately closed through the double seaming of an appropriate diameter food can end. Once seamed, the cans are given the retort sterilization cycle (time, temperature) in accordance with commercial practices. Following the retort sterilization, the cans are adequately cooled and opened with a conventional, hand operated can opener. Once opened, the contents are emptied, the inside of the can is rinsed with clean water, the can is cut in four places laterally down the sidewall and the “flattened” can is adequately dried. At this stage, the cans are ready for the film evaluations (Adhesion, TNO Global Migration, and Corrosion) described more fully below:

### Adhesion Evaluation Procedure

The headspace (“dome”) region and sidewall of the can is crosshatched in a pattern with a sharp object as described in DIN Standard No. 53151 published by Deutsches Institut für Normung e.V. of Berlin, Germany. Once this crosshatch pattern is made, this region is investigated with adhesive tape per DIN Standard No. 53151 to assess the ability of the coating to maintain adhesion in this area. The adhesion rating scale is described in DIN Standard No. 53151 ranges from GT 0 to GT 5. A rating of GT 0 means that 100% of the coating in the tested area maintains adhesion during the tape removal operation. A rating of GT 5 is issued when there is high adhesion loss in the tested area, such as when the tape removes 100% of the coating in the tested area.

### TNO Global Migration Test

The TNO global migration test is one of a number of Food Approval lacquer homologation tests (devised by the Dutch national laboratory TNO). The TNO global migration test is an extraction test using an acetic acid solution containing 3 weight percent acetic acid and 97 weight percent deionized water, based on the total weight of the acetic acid solution. The acetic acid solution is placed in contact with a coated aluminum panel under the following test conditions:—30 minutes at 100° C. followed by ten days storage at 40° C. At the end of the ten day storage period, the acetic acid solution is evaporated and the weight of any remaining extract is weighed. Passage of the TNO global migration test currently requires that the quantity of any remaining extract is 10 mg, or less, per 10 dm² of the coated aluminum panel.

### Corrosion Evaluation

Corrosion Test Procedure No. 1

Corrosion Test Procedure No. 1 entails pack testing metal food and beverage packaging containers cans with an internally applied and cured coating composition. Corrosion Test Procedure No. 1 endeavors to reproduce real commercial conditions of use of the product, to the closest extent possible. According to Corrosion Test Procedure No. 1, the coated metal food and beverage packaging containers cans are prepared using pilot scale spray application equipment and oven-curing equipment. The pilot scale spray application equipment includes spray nozzles and spray gun settings that match settings of commercial, full scale, spray application equipment.

Under the Corrosion Test Procedure No. 1, a sample of coated (and cured) metal food or beverage packaging containers is prepared using a sample coating composition (i.e., a “test” coating composition), such as a coating composition of the present invention. The coated (and cured) metal food and beverage packaging containers are then filled with a range of drinks, (beer, cola, isotonic drinks) or any of a range of foods (tomato soup, vegetables, etc.) using a pilot scale filling plant. The filled containers may then be pasteurized (or not pasteurized), depending on the normal commercial practice for the particular beverage or food placed in the containers. The filled containers are split into two different groups that are then stored at room temperature (about 20° C.) and at 37° C. for any desired period(s), such as a period of twelve months.

After the selected test period, the filled containers tested under the different temperature and storage duration variables are each opened, and the contents of the filled containers are removed. The presence or absence of any corrosion inside the containers is visually observed, rated, and noted. The rating scale extends from a rating of zero (severe corrosion visually present) to a rating of 5 (no corrosion visually present).

Corrosion Test Procedure No. 2

Though Corrosion Test Procedure No. 1 gives results that are representative of the actual real world conditions of use of the canned product, it takes a very long time to yield the results. Quicker accelerated corrosion test methods have been devised in response to faster product development. Various alternative corrosion test procedures, such as Corrosion Test Procedure No. 2, have been developed. Corrosion Test Procedure No. 2′ is an accelerated corrosion test procedure devised to predict corrosion resistance of coated (and cured) metal food and beverage packaging containers in less time than Corrosion Test Procedure No. 1 requires.

According to Corrosion Test Procedure No. 2, samples of coated (and cured) metal panels are prepared using a standard, known, commercially successful coating composition (i.e., a “control” coating composition) that is applied to both aluminum panels and to tinplate panels. Next, another sample of coated (and cured) metal panels is prepared under similar conditions using a second coating composition (i.e., a “test” coating composition), such as a coating composition of the present invention, that is also applied to both aluminum panels and to tinplate panels.

The two sets of coated (and cured) metal panels are then placed in a salt+acid test solution that is held at a temperature of 60° C. for a test period of five days. The salt+acid test solution contains a mixture of 1.5 weight percent salt (NaCl) and 1.5 weight percent acetic acid in deionized water, based on the total weight of the salt+acid test solution. At the end of the five day test period, the two sets of coated (and cured) metal panels are examined both visually and under a microscope for signs of corrosion.

If the appearance of the coated (and cured) metal panels prepared using the test coating matches or exceeds the appearance of the coated (and cured) metal panels prepared using the control coating, this is generally a good indication the test coating is likely to pass the long term pack test procedure, namely Corrosion Test Procedure No. 1. Also, if the appearance of the coated (and cured) metal panels prepared using the test coating matches or exceeds the appearance of the coated (and cured) metal panels prepared using the control coating, this is generally a good indication the test coating is likely to pass the TNO global migration test.

Corrosion Test Procedure No. 3

Though Corrosion Test Procedure No. 1 gives results representative of actual real world conditions of use of the canned product, it takes a very long time to yield the results. Quicker accelerated corrosion test methods have been devised in response to faster product development. Various alternative corrosion test procedures, such as Corrosion Test Procedure No. 3, have been developed. Corrosion Test Procedure No. 3 is an accelerated corrosion test procedure devised to predict corrosion resistance of coated (and cured) metal food and beverage packaging containers in less time than Corrosion Test Procedure No. 1 requires.

According to Corrosion Test Procedure No. 3, samples of coated (and cured) metal food and beverage packaging containers are prepared using a sample coating composition (i.e., a “test” coating composition), such as a coating composition of the present invention, that is applied to the interior of both aluminum packaging containers and to tinplate packaging containers and then cured. The coated (and cured) metal food and beverage packaging containers are then filled with a test solution known as Coke L85 using a pilot scale filling plant. The Coke L85 solution contains phosphoric acid, citric acid and salt. The two sets of filled containers are then stored at 37° C. for a desired test period.

After the test period is complete, the contents of the filled containers are analyzed for either dissolved iron (if tinplate containers are used) or dissolved aluminum (if aluminum containers are used). Results obtained using this test have correlated well with results obtained using real pack testing, such as results obtained using Corrosion Test Procedure No. 1. Under one test standard, when tested according to Corrosion Test Procedure No. 3 using a ten day test period, the contents of the coated (and cured) metal food and beverage packaging containers will average (based on twelve different containers) a dissolved iron (if tinplate containers are used) concentration of 0.5 parts per million (ppm) or less, on a weight basis, or a dissolved aluminum (if aluminum containers are used) concentration of 0.1 parts per million (ppm) or less, on a weight basis. Under this standard following a ten day test period, no individual one of the tinplate containers should contain greater than 1.0 ppm dissolved iron on a weight basis, and, no individual one of the aluminum containers should contain greater than 0.20 ppm dissolved aluminum on a weight basis.

Acid Number Determination Procedure

The acid number of a particular polymer, such as polyester or polyester acrylate, may be determined using ASTM Standard No. D3644-98 (2004) that is entitled Standard Test Method for Acid Number of Styrene-Maleic Anhydride Resins. ASTM Standard No. D3644-98 is published by, and may be obtained from, ASTM International of West Conshohocken, Pa.: Unless otherwise stated, all acid number values for any polymer or resin, when stated as an acid value without providing accompanying units, are to be understood as being provided in units of: mg KOH per gram of the polymer or resin.

Hydroxyl Number Determination Procedure

The hydroxyl number of a particular polymer, such as polyester or polyester acrylate, may be determined using ASTM Standard No. E222-00, which is entitled Standard Test Methods for Hydroxyl Groups Using Acetic Anhydride Acetylation. ASTM Standard No. E22-00 is published by, and may be obtained from, ASTM International of West Conshohocken, Pa.: Unless otherwise stated, all hydroxyl number values for any polymer or resin, when stated as an hydroxyl value without providing accompanying units, are to be understood as being provided in units of: mg KOH per gram of the polymer or resin.

Viscosity Determination Procedure #1

Viscosity Determination Procedure #1 entails determining the viscosity of a fluid sample at a particular sample temperature, such as a temperature of about 50° C., using an REL Cone & Plate Viscometer that is available from Research Equipment Limited of Twickenham, United Kingdom. Viscosity determination according to Viscosity Determination Procedure #1 using an REL Cone & Plate Viscometer follows ASTM (American Society for Testing and Materials; West Conshohocken, Pa.) Standard D4287-00 (entitled “Standard Test Method for High-Shear Viscosity Using a Cone/Plate Viscometer”) along with the instructions in the operating manual provided with the REL Cone & Plate Viscometer.

Viscosity Determination Procedure #2

Viscosity Determination Procedure #2 entails determining the viscosity of a fluid sample at a particular sample temperature, such as a temperature of about 20° C., in accordance with ASTM (American Society for Testing and Materials; West Conshohocken, Pa.) Standard D1200-94 (1999) that is entitled “Standard Test Method for Viscosity by Ford Viscosity Cup.” As an alternative to using a Ford viscosity cup, such as a Ford #4 viscosity cup, viscosity determinations made using this Viscosity Determination #2 may employ an AFNOR cup, such as an AFNOR #4 cup.

Viscosity Determination Procedure #3

Viscosity Determination Procedure #3 entails determining the viscosity of a fluid sample at a particular sample temperature, such as a temperature of about 25° C., using a Brookfield Model LVT dial reading viscometer that is available from Brookfield Engineering Laboratories, Inc. of Stoughton, Mass. Viscosity determination according to Viscosity Determination Procedure #3 follows the instructions in the operating manual provided with the Brookfield Model LVT dial reading viscometer. An appropriate spindle, identified by a spindle number and selected so the measured viscosity is within the range of the particular spindle, is positioned within the measurement cell. The Brookfield viscosity is measured while running the selected spindle at a revolution per minute (RPM) rate selected based upon calibration studies conducted at the direction of the inventor.

Particle Size Determination Procedure

Particle size profiles recited in this document are based on particle size determinations made with the Beckman-Coulter LSTM 230 Laser Diffraction Particle Size Analyzer in accordance with the instruction manual provided with the Beckman-Coulter LSTM 230 Particle Size Analyzer. The Beckman-Coulter LSTM 230 Particle Size Analyzer Beckman-Coulter LS™ 230 Particle Size Analyzer may be obtained from Beckman Coulter, Inc. of Fullerton, Calif.

Total Solids Determination Procedure

The actual weight of total solids (non-volatile matter) of a particular sample containing polyester or polyester acrylate may be determined by first measuring out one gram of the “as is” sample. The one gram sample is then placed in an oven with an internal temperature of 110° C. for a one hour drying period. The weight of the dried sample that remains constitutes the actual weight of total solids (non-volatile matter) in the original one gram “as is” sample. The weight percent total solids (non-volatile matter) in the original “as is” sample may then be calculated by dividing the actual weight of total solids after drying by the actual weight (one gram) of the original one gram “as is” sample and multiplying this result by 100%.

Water Content Determination Procedure

The water content of a particular sample may be determined using the Karl Fisher titration technique of ASTM Standard No. E203-01, which is entitled Standard Test Method for Water Using Volumetric Karl Fischer Titration. ASTM Standard No. E203-01 is published by, and may be obtained from, ASTM International of West Conshohocken, Pa. The concentration of water in the volatile portion of the sample may be determined by first subtracting the actual weight of total solids (non-volatile matter) present in the sample (as determined using the Total Solids Determination Procedure) from the total “as is” weight of the sample to get the total weight of the volatile portion of the sample. The concentration of water in the volatile portion of the sample may then be calculated by dividing the actual weight of water determined in accordance with this procedure by the total weight of the volatile portion of the sample and multiplying this result by 100%.

VOC Content Determination Procedure

The concentration of VOC (volatile organic compound) in the volatile portion of a particular sample may be calculated according to this procedure. First, the actual weight of total solids (non-volatile matter) present in the sample (as determined using the Total Solids Determination Procedure) and the actual weight of water present in the volatile portion of the sample (as determined using the Water Content Determination Procedure) are subtracted from the total “as is” weight of the sample to get the total weight of VOC in the volatile portion of the sample. The concentration of VOC in the volatile portion of the sample may then be calculated by dividing the actual weight of VOC determined in accordance with this procedure by the total weight of the volatile portion of the sample and multiplying this result by 100%.

The weight of VOC (volatile organic compound) per unit weight of the non-volatile matter portion of a particular sample (grams VOC per kilogram dry coating, for example) may be calculated according to this procedure. First, the total weight of VOC in the volatile portion of the sample is calculated as described earlier in this procedure. Then, the total weight of VOC in the volatile portion of the sample is divided by the actual weight of total solids (non-volatile matter) present in the sample (as determined using the Total Solids Determination Procedure) to determine the weight of VOC (volatile organic compound) per unit weight of the non-volatile matter portion in sample (dry weight of the aqueous dispersion).

The weight of VOC (volatile organic compound) per unit volume of the sample (grams VOC per gallon of the sample) may be calculated according to this procedure. First, the total weight of VOC in the volatile portion of the sample of the sample is calculated as described earlier in this procedure. Then, the total weight of VOC in the volatile portion of the sample is divided by the actual volume of the sample of the sample to determine the weight of VOC (volatile organic compound) per unit volume of the sample.

### EXAMPLES

The following examples are offered to aid in understanding of the present invention and are not to be construed as limiting the scope thereof. Unless otherwise indicated, all parts and percentages are by weight.

### Example 1

### Polyester Synthesis

In this Example, ten different polyesters with formulations A-J (see Table 10 were synthesized in accordance with the present invention. Details of the syntheses of these ten different polyesters are provided following Table 1.

TABLE 1

| | | POLYESTER FORMULATION | | | | | | | | | |
|---|---|---|---|---|---|---|---|---|---|---|---|
| | | (Weight Percent*) | | | | | | | | | |
| COMPONENT | | A | B | C | D | E | F | G | H | I | J |
| POLYHYDRIC | Neopentyl Glycol | 24.5 | | | | | | | | | |
| ALCOHOL | Trimethylol Propane | 17.5 | 3.8 | 6.1 | 2.7 | 5.1 | 5.0 | 5.1 | 5.0 | 5.0 | 4.6 |
| | Propylene Glycol | | 12.3 | 28.3 | 16.7 | 29.5 | 31.1 | 29.5 | 31.2 | 31.2 | 28.5 |
| | 1,4,cyclohexanedimethanol | | 24.7 | | 6.8 | | | | | | |
| | Ethylene Glycol | | | | 5.9 | | | | | | |
| POLYBASIC | Lauric Acid | 8.3 | | | | | | | | | |
| ACID | Adipic Acid | 15.5 | | | | | | | | | |
| | Terephthalic Acid | 6.6 | 16.4 | 28.1 | 11.1 | 28.0 | 55.1 | 28.0 | 55.0 | 55.0 | |
| | Isophthalic Acid | | 41.9 | 7.5 | | 7.5 | 7.8 | 7.5 | 7.8 | 7.8 | 7.2 |
| | Dimethyl Terephthalate | | | 29.0 | 49.8 | 28.9 | | 28.9 | | | 58.8 |
| | 1,4 Cyclohexane dicarboxylic Acid | | | | 6.1 | | | | | | |
| POLYBASIC | Phthalic Anhydride | 27.4 | | | | | | | | | |
| ANHYDRIDE | Maleic Anhydride | 0.2 | 0.9 | 1.0 | 0.9 | 1.0 | 1.0 | 1.0 | 1.0 | 1.0 | 0.9 |

*Based on the total weight of the respective polyester formulations

### Example 1

### Polyester A

A 5-liter flask was equipped with a stirrer, packed column, condenser, thermocouple, heating mantle, and nitrogen blanket. 385.0 grams of trimethylol propane, 183.0 grams of lauric acid and 1.9 grams of the REATINOR® 932 octyl-tin mercaptide polymerization stabilizer were added to the 5-liter flask. The flask contents were slowly heated to 215° C.-220° C. under a nitrogen blanket, and the water created during the resulting polycondensation reaction was distilled off. Once the acid number of the reaction mixture fell below 5, the flask contents were cooled to 170° C., and 541.0 grams of neopentyl glycol, 343.0 grams of adipic acid, 145.0 grams of terephthalic acid, 604.0 grams of phthalic anhydride and 5.0 grams of maleic anhydride were added to the 5-liter flask.

The mixture was slowly reheated to 235° C.-240° C. under a nitrogen blanket and more water was distilled off. Once the acid number of the mixture fell below 30, the reaction mixture was cooled to 200° C., the packed column was replaced with a Dean & Stark column (available from Kimble/Kontes of Vineland, N.J. USA) for azeotropic distillation and 113.0 grams of xylene were added to the flask. The contents of the flask were reheated under a nitrogen blanket to reflux temperature and more reaction water was distilled off until the acid number of the reaction mixture fell below 5. The contents of the flask were then cooled to 145° C.-150° C., and 512.0 grams of butylglycol were thereafter added to the flask to form a solution of dissolved Polyester A.

The solution of dissolved Polyester A had a solids concentration of 76.6 weight percent, based on the total weight of the solution of dissolved Polyester A, as determined in accordance with the Total Solids Determination procedure provided above. The acid number of Polyester A was determined to be 7.5 using the Acid Number Determination Procedure set forth.

### Example 1

### Polyester B

A 5-liter flask was equipped with a stirrer, packed column, condenser, thermocouple, heating mantle, and nitrogen blanket. 386.8 grams of propylene glycol, 779.0 grams of 1,4-cyclohexanedimethanol, 517.9 grams of terephthalic acid and 2.7 grams of dibutyltin laureate (a polymerization stabilizer) were added to the 5-liter flask. The flask contents were slowly heated to 215° C.-220° C. under a nitrogen blanket, and the water created during the resulting polycondensation reaction was distilled off. Once the reaction mixture became clear, the flask contents were cooled to 180° C. and 120.8 grams of trimethylol propane, 1322.5 grams of isophthalic acid, and 29.7 grams of maleic anhydride were added to the 5-liter flask.

The mixture was slowly reheated to 215° C.-220° C. under a nitrogen blanket and more water was distilled off. Once the acid number of the mixture fell below 30, the reaction mixture in the flask was cooled to 200° C. and the packed column was replaced with a Dean & Stark column (available from Kimble/Kontes of Vineland, N.J. USA) for azeotropic distillation and 29.7 grams of xylene were added to the flask. The contents of the flask were reheated under a nitrogen blanket to reflux temperature and more reaction water was distilled off until the acid number of the reaction mixture fell below 5. The contents of the flask were then cooled to 145° C.-150° C., and 1431.0 grams of butyl glycol, 201.1 grams of n-butanol, and 422.1 grams of xylene were added to the flask to form a solution of dissolved Polyester B.

The solution of dissolved Polyester B had a solids concentration of 55.2 weight percent, based on the total weight of the solution of dissolved Polyester B, as determined in accordance with the Total Solids Determination procedure provided above. The acid number of Polyester B was determined to be 2.3 using the Acid Number Determination Procedure set forth above. The solution of dissolved Polyester B had a viscosity of 22 poise, as determined at a sample temperature of 50° C. using the REL Cone & Plate Viscometer in accordance with Viscosity Determination Procedure #1 provided above.

### Example 1

### Polyester C

A 5-liter flask was equipped with a stirrer, packed column, condenser, thermocouple, heating mantle and nitrogen blanket. 511.9 grams of propylene glycol, 111.4 grams of trimethylol propane, 524.7 grams of dimethyl terephthalate and 1.5 grams of FASCAT® 9100 catalyst product were added to the 5-liter flask. The flask contents were slowly heated to 220° C.-230° C. under a nitrogen blanket, and the methanol created during the resulting transesterification reaction was distilled off until the reaction mixture became clear and the temperature of the column head dropped. The contents of the flask were cooled to 180° C. and 508.3 grams of terephthalic acid were added. The reaction mixture was slowly reheated to 220-230° C. under a nitrogen blanket and water was distilled off until the temperature of the column head dropped and the reaction mixture became clear. The flask contents were then cooled to 180° C. and 136.1 grams of isophthalic acid and 17.3 grams of maleic anhydride were added to the 5-liter flask.

The reaction mixture was slowly reheated to 220° C.-230° C. under a nitrogen blanket and water was distilled off until the mixture became clear and the temperature of the column head dropped. After cooling to 200° C., the packed column was replaced with a Dean & Stark column for azeotropic distillation and 13.2 grams of xylene were added to the flask. The contents of the flask were reheated under a nitrogen blanket to reflux temperature and more reaction water was distilled off until the acid number of the reaction mixture fell below 6. The contents of the flask were cooled to 145° C.-150° C., and 811.8 grams of butyl glycol, 114.3 grams of n-butanol, and 229.0 grams of xylene were then added to form a solution of dissolved Polyester C.

The solution of dissolved Polyester C had a solids concentration of 54.8 weight percent, based on the total weight of the solution of dissolved Polyester C, as determined in accordance with the Total Solids Determination procedure provided above. The acid number of Polyester C was determined to be 4.2 using the Acid Number Determination Procedure set forth above. The solution of dissolved Polyester C had a viscosity of 18.2 poise, as determined at a sample temperature of 50° C. using the REL Cone & Plate Viscometer in accordance with Viscosity Determination Procedure #1 provided above.

### Example 1

### Polyester D

A 2-liter flask was equipped with a stirrer, packed column, condenser, thermocouple, heating mantle, and nitrogen blanket. 264.3 grams of propylene glycol, 106.6 grams of 1,4-cyclohexanedimethanol, 42.6 grams of trimethylolpropane, 92.5 grams of ethylene glycol and 786.8 grams of dimethyl terephthalate and 0.7 grams of FASCAT® 4201 catalyst product were added to the flask. The flask contents were slowly heated to 215° C.-220° C. under a nitrogen blanket and the methanol created during the resulting transesterification reaction was distilled off. Once the reaction mixture became clear, the flask contents were cooled to 180° C., and 174.7 grams of terephthalic acid, 96.8 grams of 1,4-cyclohexanedicarboxylic acid and 14.6 grams of maleic anhydride were then added to the flask.

The reaction mixture was slowly reheated to 235° C. under a nitrogen blanket and water was distilled off. Once the reaction mixture became clear, the reactor was cooled to 200° C., the packed column was replaced with a Dean & Stark column for azeotropic distillation, and 40.0 grams of xylene were added to the flask. The contents of the flask were reheated under a nitrogen blanket to reflux temperature, and more reaction water was distilled off until the acid number of the reaction mixture fell below 4. The contents of the flask were cooled to 145° C.-150° C., and 690.3 grams of butyl glycol, 97.8 grams of n-butanol, and 191.3 grams of xylene were then added to form a solution of dissolved Polyester D.

The solution of dissolved Polyester D had a solids concentration of 54.5 weight percent, based on the total weight of the solution of dissolved Polyester D, as determined in accordance with the Total Solids Determination procedure provided above. The acid number of Polyester D was determined to be 10 using the Acid Number Determination Procedure set forth above.

### Example 1

### Polyester E

A 2-liter flask was equipped with a stirrer, packed column, condenser, thermocouple, heating mantle and nitrogen blanket. 440.7 grams of propylene glycol, 76.5 grams of trimethylolpropane, 432.7 grams of dimethyl terephthalate and 1.4 grams of FASCATφ 9100 catalyst product were added to the flask. The flask contents were then slowly heated to 205° C. under a nitrogen blanket, and the methanol created during the resulting transesterification reaction was distilled off. Once the temperature of the column head dropped and the distillation slowed down, the flask contents were cooled to 180° C., and 419.2 grams of terephthalic acid was added to the flask. The reaction mixture was slowly reheated to 225° C.-230° C. under a nitrogen blanket, and water was distilled off. Once the reaction mixture became clear, the flask contents were cooled to 180° C., and 112.2 grams of isophthalic acid and 14.3 grams of maleic anhydride were added to the flask.

The reaction mixture in the flask was slowly reheated to 225° C.-230° C. until the temperature of the head of the packed column dropped and the distillation slowed down. The reaction mixture in the flask was cooled to 200° C., and the packed column was replaced with a Dean & Stark column for azeotropic distillation. 27.9 grams of xylene were then added to the flask. The contents of the flask were reheated under a nitrogen blanket to reflux temperature, and more reaction water was distilled off until the acid number of the reaction mixture fell below 3. The contents of the flask were cooled to 145° C.-150° C., and 662.4 grams of butyl glycol, 93.1 grams of n-butanol, and 179.2 grams of xylene were added to form a solution of dissolved Polyester E.

The solution of dissolved Polyester E had a solids concentration of 55.1 weight percent, based on the total weight of the solution of dissolved Polyester E, as determined in accordance with the Total Solids Determination procedure provided above. The acid number of Polyester E was determined to be 2.4 using the Acid Number Determination Procedure set forth above. The solution of dissolved Polyester E had a viscosity of 10 poise, as determined at a sample temperature of 50° C. using the REL Cone & Plate Viscometer in accordance with Viscosity Determination Procedure #1 provided above.

### Example 1

### Polyester F

A 2-liter flask was equipped with a stirrer, packed column, condenser, thermocouple, heating mantle and nitrogen blanket. 496.9 grams of propylene glycol, 80.1 grams of trimethylolpropane, 880.1 grams of terephthalic acid, 125.5 grams of isophthalic acid, 16.0 grams of maleic anhydride and 3.0 grams of FASCAT® 9100 catalyst product were added to the flask. The flask contents were slowly heated to 225° C.-235° C. under a nitrogen blanket, and the water from the resulting polycondensation reaction was distilled off.

Once the reaction mixture became clear and the temperature at the head of the packed column dropped, the reaction mixture in the flask was cooled to 200° C., the packed column replaced with a Dean & Stark column for azeotropic distillation, and 30.0 grams of xylene were added to the flask. The contents of the flask were reheated under a nitrogen blanket to reflux temperature, and more reaction water was distilled off until the acid number of the reaction mixture fell below 5. The contents of the flask were cooled to 145° C.-150° C., and 744.6 grams of butyl glycol, 104.7 grams of n-butanol, and 219.6 grams of xylene were then added to form a solution of dissolved Polyester F.

The solution of dissolved Polyester F had a solids concentration of 55.9 weight percent, based on the total weight of the solution of dissolved Polyester F, as determined in accordance with the Total Solids Determination procedure provided above. The acid number of Polyester F was determined to be 3.2 using the Acid Number Determination Procedure set forth above. The solution of dissolved Polyester F had a viscosity of 8.4 poise, as determined at a sample temperature of 50° C. using the REL Cone & Plate Viscometer in accordance with Viscosity Determination Procedure #1 provided above.

### Example 1

### Polyester G

Synthesis of Polyester E was repeated on a pilot scale at a batch size of 120 kg. The formulation of Polyester G was the same as the formulation for Polyester E. 24610 grams of propylene glycol, 4274 grams of trimethylolpropane, 24164 grams of dimethyl terephthalate and 78 grams of FASCAT® 9100 product were added to a reactor. The contents of the reactor were slowly heated to 205° C. under a nitrogen blanket and the methanol from the resulting transesterification reaction was distilled off. Once the temperature of the column head dropped and the distillation slowed down, the reactor contents were cooled to 180° C., and 23408 grams of terephthalic acid were added to the reactor. The mixture was slowly reheated to 225° C.-230° C. under a nitrogen blanket, and water was distilled off. Once the reaction mixture became clear, the reactor contents were cooled to 180° C., and 6266 grams of isophthalic acid and 799 grams of maleic anhydride were added to the reactor.

The reaction mixture was slowly reheated to 225° C.-230° C. until the temperature at the head of the packed column dropped and the distillation slowed down. The reaction mixture was cooled to 170° C., the packed column was replaced with a Dean & Stark column for azeotropic distillation, and 1579 grams of xylene were added to the reactor. The contents of the reactor were reheated under a nitrogen blanket to reflux temperature, and more reaction water was distilled off until the acid number of the reaction mixture fell below 5. The contents of the reactor were cooled to 145° C.-150° C., and 26770 grams of butyl glycol, 5359 grams of n-butanol, and 11073 grams of xylene were added to form a solution of dissolved Polyester G.

The solution of dissolved Polyester G had a solids concentration of 58.9 weight percent, based on the total weight of the solution of dissolved Polyester G, as determined in accordance with the Total Solids Determination procedure provided above. The acid number of Polyester G was determined to be 3.9 using the Acid Number Determination Procedure set forth above. The solution of dissolved Polyester G had a viscosity of 8.6 poise, as determined at a sample temperature of 50° C. using the REL Cone & Plate Viscometer in accordance with Viscosity Determination Procedure #1 provided above.

### Example 1

### Polyester H

A 2-liter flask was equipped with a stirrer, packed column, condenser, thermocouple, heating mantle and nitrogen blanket. 498.6 grams of propylene glycol, 80.1 grams of trimethylolpropane, 880.1 grams of terephthalic acid, 40.0 grams of isophthalic acid and 2.0 grams of FASCAT® 9100 catalyst product were added to the flask. The flask contents were slowly heated to 225° C.-235° C. under a nitrogen blanket, and the water from the resulting polycondensation reaction was distilled off. Once the reaction mixture became clear and the temperature at the head of the column dropped, the reaction mixture was cooled to 160° C., and 85.5 grams of isophthalic acid and 16.0 grams of maleic anhydride were added to the flask. The reaction mixture was slowly reheated under a nitrogen blanket to 220° C.-230° C.

Once the reaction mixture became clear and the temperature at the head of the packed column dropped, the reaction mixture in the flask was cooled to 200° C., the packed column replaced with a Dean & Stark column for azeotropic distillation, and 30.0 grams of xylene were added to the flask. The contents of the flask were reheated under a nitrogen blanket to reflux temperature, and more reaction water was distilled off until the acid number of the reaction mixture fell below 5. The contents of the flask were cooled to 145° C.-150° C., and 744.6 grams of butyl glycol, 104.7 grams of n-butanol, and 219.6 grams of xylene were then added to form a solution of dissolved Polyester H.

The solution of dissolved Polyester H had a solids concentration of 55.2 weight percent, based on the total weight of the solution of dissolved Polyester H, as determined in accordance with the Total Solids Determination procedure provided above. The acid number of Polyester H was determined to be 3.4 using the Acid Number Determination Procedure set forth above. The solution of dissolved Polyester H had a viscosity of 11.5 poise, as determined at a sample temperature of 50° C. using the REL Cone & Plate Viscometer in accordance with Viscosity Determination Procedure #1 provided above.

### Example 1

### Polyester I

A 2-liter flask was equipped with a stirrer, packed column, condenser, thermocouple, heating mantle and nitrogen blanket. 498.8 grams of propylene glycol, 80.1 grams of trimethylolpropane, 880.1 grams of terephthalic acid, 125.5 grams of isophthalic acid, and 2.0 grams of FASCAT® 9100 catalyst product were added to the flask. The flask contents were slowly heated to 225° C.-235° C. under a nitrogen blanket, and the water from the resulting polycondensation reaction was distilled off.

Once the reaction mixture became clear and the temperature at the head of the packed column dropped, the reaction mixture in the flask was cooled to 170° C., the packed column was replaced with a Dean & Stark column for azeotropic distillation, and 16.0 grams of maleic anhydride and 30.0 grams of xylene were added to the flask. The contents of the flask were reheated under a nitrogen blanket to reflux temperature, and more reaction water was distilled off until the acid number of the reaction mixture fell below 5. The contents of the flask were cooled to 145° C.-150° C., and 744.6 grams of butyl glycol, 104.7 grams of n-butanol, and 219.6 grams of xylene were then added to form a solution of dissolved Polyester I.

The solution of dissolved Polyester I had a solids concentration of 55.2 weight percent, based on the total weight of the solution of dissolved Polyester I, as determined in accordance with the Total Solids Determination procedure provided above. The acid number of Polyester I was determined to be 3.4 using the Acid Number Determination Procedure set forth above. The solution of dissolved Polyester I had a viscosity of 7.5 poise, as determined at a sample temperature of 50° C. using the REL Cone & Plate Viscometer in accordance with Viscosity Determination Procedure #1 provided above.

### Example 1

### Polyester J

A 2-liter flask was equipped with a stirrer, packed column, condenser, thermocouple, heating mantle and nitrogen blanket. 498.8 grams of propylene glycol, 80.1 grams of trimethylolpropane, 1028.7 grams of dimethyl terephthalate and 2.0 grams of FASCAT® 9100 catalyst product were added to the flask. The flask contents were slowly heated to 225° C.-235° C. under a nitrogen blanket, and the methanol from the resulting transesterification reaction was distilled off. Once the reaction mixture became clear and the temperature at the head of the column dropped, the reactor was cooled to 160° C., and 125.5 grams of isophthalic acid and 16.0 grams of maleic anhydride were added to the flask. The reaction mixture was reheated slowly under a nitrogen blanket to 220° C.-230° C.

Once the reaction mixture became clear and the temperature at the head of the packed column dropped, the reaction mixture in the flask was cooled to 180° C., the packed column was replaced with a Dean & Stark column for azeotropic distillation, and 30.0 grams of xylene were then added to the flask. The contents of the flask were reheated under a nitrogen blanket to reflux temperature, and more reaction water was distilled off until the acid number of the reaction mixture fell below 5. The contents of the flask were cooled to 145° C.-150° C., and 744.6 grams of butyl glycol, 104.7 grams of n-butanol, and 219.6 grams of xylene were then added to form a solution of dissolved Polyester J.

The solution of dissolved Polyester J had a solids concentration of 55.1 weight percent, based on the total weight of the solution of dissolved Polyester J, as determined in accordance with the Total Solids Determination procedure provided above. The acid number of Polyester J was determined to be 2.4 using the Acid Number Determination Procedure set forth above. The solution of dissolved Polyester J had a viscosity of 4.9 poise, as determined at a sample temperature of 50° C. using the REL Cone & Plate Viscometer.

### Example 2

### Polyester Acrylate Synthesis

In this Example, fifteen different polyester acrylates were synthesized in accordance with the present invention. Details of the syntheses of these fifteen different polyester acrylates are provided below.

### Example 2

### Polyester Acrylate 1

A 4-liter flask was equipped with a stirrer, reflux condenser, thermocouple, heating mantle and nitrogen blanket. 1197.0 grams of the solution of dissolved Polyester A that was prepared in “Example 1—Polyester A” was placed in the 4-liter flask and preheated under a nitrogen blanket to 135° C. In a separate flask, 277.0 grams of ethyl acrylate, 59.0 grams of glacial acrylic acid, 83.0 grams of styrene, and 17.1 grams of VAZO® 67 free radical initiator were premixed. The mixture of monomers and initiator was then added over a period of two hours to the polyester solution under a nitrogen blanket at a temperature of 133° C.-135° C. After the monomer/initiator addition was complete, the temperature in the 4-liter flask was maintained for one hour at 133° C.-135° C.

Then, 2.2 grams of the TRIGONOX® C free radical initiator were added to the 4-liter flask, and the temperature was maintained at 133° C.-135° C. for two hours. The reaction mixture was then cooled to 110° C., and a premix containing 80.0 grams of dimethylethanolamine and 80.0 grams of demineralized water was added over a ten minute period, followed by a hold of 15 minutes. The reaction mixture dropped in temperature to about 100° C. at the end of the addition and to about 95° C. at the end of the hold, respectively. Finally, 1120 grams of demineralized water were added over 30 minutes, and the solution of the polyester acrylate inverted into an aqueous dispersion of Polyester Acrylate 1.

The aqueous dispersion of Polyester Acrylate 1 had a solids concentration of about 30 weight percent, based on the total weight of the aqueous dispersion of Polyester Acrylate 1, as determined in accordance with the Total Solids Determination procedure provided above. The acid number of Polyester Acrylate 1 was determined to be 37 using the Acid Number Determination Procedure set forth above. The aqueous dispersion of Polyester Acrylate 1 had a pH of 8.53 standard pH units at a temperature of about 20° C. The aqueous dispersion of Polyester Acrylate 1 had a viscosity of 176 seconds, as determined in accordance with Viscosity Determination Procedure #2 provided above using an AFNOR #4 cup at a sample temperature of 20° C.

### Example 2

### Polyester Acrylate 2

A 5-liter flask was equipped with a stirrer, reflux condenser, thermocouple, heating mantle, and nitrogen blanket. 1094.4 grams of the solution of dissolved Polyester B that was prepared in “Example 1—Polyester B” was placed in the 5-liter flask and preheated under a nitrogen blanket to 135° C. In a separate flask, 184.7 grams of ethyl acrylate, 39.3 grams of glacial acrylic acid, 55.3 grams of styrene, and 11.4 grams of VAZO® 67 free radical initiator were premixed. The mixture of monomers and initiator was then added over a three. hour period to the polyester solution under a nitrogen blanket at a temperature of 132° C.-136° C. The temperature in the 5-liter flask was then maintained for one hour at 132° C.-136° C.

Then, 1.5 grams of the TRIGONOX® C free radical initiator were added to the 5-liter flask, and the temperature in the 5-liter flask was maintained at 132° C.-136° C. for two hours. The reaction mixture was then cooled to 109° C. and a premix containing 53.3 grams of dimethylethanolamine and 53.3 grams of demineralized water was added to the 5-liter flask over a ten minute period, followed by a hold of 15 minutes. The reaction mixture dropped in temperature to 103° C. at the end of the addition and to 95° C. at the end of the hold, respectively. Finally 1496 grams of water were added to the 5-liter flask over a thirty minute period, and the solution of the polyester acrylate inverted into an aqueous dispersion of Polyester Acrylate 2.

The aqueous dispersion of Polyester Acrylate 2 had a solids concentration of 30.0 weight percent, based on the total weight of the aqueous dispersion of Polyester Acrylate 2, as determined in accordance with the Total Solids Determination procedure provided above. The acid number of Polyester Acrylate 2 was determined to be 34.3 using the Acid Number Determination Procedure set forth above. The aqueous dispersion of Polyester Acrylate 2 had a pH of 8.78 standard pH units at a temperature of about 20° C. The aqueous dispersion of Polyester Acrylate 2 had a viscosity of 66 seconds, as determined in accordance with Viscosity Determination Procedure #2 provided above using an AFNOR #4 cup at a sample temperature of 20° C.

### Example 2

### Polyester Acrylate 3

A 2-liter flask was equipped with a stirrer, reflux condenser, thermocouple, heating mantle, and nitrogen blanket. 830.0 grams of the solution of dissolved Polyester C that was prepared in “Example 1—Polyester C” was placed in the 2-liter flask and preheated under a nitrogen blanket to 135° C. In a separate flask, 139.2 grams of ethyl acrylate, 29.6 grams of glacial acrylic acid, 41.7 grams of styrene, and 8.6 grams of VAZO® 67 free radical initiator were premixed. The mixture of monomers and initiator was then added over 140 minutes to the polyester solution under a nitrogen blanket at a temperature of 132° C.-136° C. The temperature in the 2-liter flask was then maintained for one hour at 135° C.-136° C.

Then, 1.3 grams of the TRIGONOX® C free radical initiator were added to the 2-liter flask, and the reactor temperature was kept for two hours at 132° C.-136° C. The reaction mixture was then cooled to 110° C., and a premix containing 36.6 grams of dimethylethanolamine and 36.6 grams of demineralized water was added to the 2-liter flask over a ten minute period. The reaction mixture dropped in temperature to 100° C. at the end of the addition and was held for 15 minutes at 100° C. Finally, 1127 grams of water were added over a thirty minute period, and the solution of the polyester acrylate inverted into an aqueous dispersion of Polyester Acrylate 3.

The aqueous dispersion of Polyester Acrylate 3 had a solids concentration of 29.9 weight percent, based on the total weight of the aqueous dispersion of Polyester Acrylate 3, as determined in accordance with the Total Solids Determination procedure provided above. The acid number of Polyester Acrylate 3 was determined to be 33.3 using the Acid Number Determination Procedure set forth above. The aqueous dispersion of Polyester Acrylate 3 had a pH of 8.49 standard pH units at a temperature of about 20° C. The aqueous dispersion of Polyester Acrylate 3 had a viscosity of 114 seconds, as determined in accordance with Viscosity Determination Procedure #2 provided above using an AFNOR #4 cup at a sample temperature of 20° C.

### Example 2

### Polyester Acrylate 4

A 2-liter flask was equipped with a stirrer, reflux condenser, thermocouple, heating mantle, and nitrogen blanket. 834.0 grams of the solution of dissolved Polyester D that was prepared in “Example 1—Polyester D” was placed in the 2-liter flask and preheated under a nitrogen blanket to 135° C. In a separate flask, 137.7 grams of ethyl acrylate, 29.3 grams of glacial acrylic acid, 41.2 grams of styrene, and 8.5 grams of VAZO® 67 free radical initiator were premixed. The mixture of monomers and initiator was then added over to the polyester solution over a period of 128 minutes under a nitrogen blanket and at a temperature of 135° C.-137° C. The temperature in the 2-liter flask was then maintained at 135° C. for one hour.

Then, 1.1 grams of the TRIGONOX® C. free radical initiator were added to the 2-liter flask and the temperature in the two liter flask was held at 135° C. for two hours. The reaction mixture was then cooled to 110° C. and a premix containing 36.3 grams of dimethylethanolamine and 36.3 grams of demineralized water was added to the 2-liter flask over a ten minute period, followed by a hold of 15 minutes. The reaction mixture dropped in temperature to 103° C. at the end of the addition and to 95° C. at the end of the hold respectively. Finally, 1096 grams of water were added to the 2-liter flask over a thirty minute period, and the solution of the polyester acrylate inverted into an aqueous dispersion of Polyester Acrylate 4.

The aqueous dispersion of Polyester Acrylate 4 had a solids concentration of 30.2 weight percent, based on the total weight of the aqueous dispersion of Polyester Acrylate 4, as determined in accordance with the Total Solids Determination procedure provided above. The acid number of Polyester Acrylate 4 was determined to be 34.1 using the Acid Number Determination Procedure set forth above. The aqueous dispersion of Polyester Acrylate 4 had a pH of 8.27 standard pH units at a temperature of about 20° C. The aqueous dispersion of Polyester Acrylate 4 had a viscosity of 105 seconds, as determined in accordance with Viscosity Determination Procedure #2 provided above using an AFNOR #4 cup at a sample temperature of 20° C.

### Example 2

### Polyester Acrylate 5

A 5-liter flask was equipped with a stirrer, reflux condenser, thermocouple, heating mantle, and nitrogen blanket. 1782.0 grams of the solution of dissolved Polyester G prepared in “Example 1—Polyester G” and 123.0 grams of butyl glycol were placed in the 5-liter flask and preheated under a nitrogen blanket to 133° C. In a separate flask, 321.0 grams of ethyl acrylate, 68.3 grams of glacial acrylic acid, 96.1 grams of styrene, and 19.9 grams of VAZO® 67 free radical initiator were premixed. The mixture of monomers and initiator was then added to the polyester solution over a period of 135 minutes under a nitrogen blanket and at a temperature of 132° C.-133° C. The temperature in the 5-liter flask was then maintained for one hour at 132° C.

Then, 2.6 grams of the TRIGONOX® C free radical initiator were added to the 5-liter flask, and the reactor temperature was maintained for two hours at 132° C. The reaction mixture was then cooled to 105° C., and a premix containing 150.3 grams of dimethylethanolamine and 150.3 grams of demineralized water was added to the 5-liter flask over a ten minute period, followed by a hold of 10 minutes. The reaction mixture dropped in temperature to 90° C. at the end of the addition. Finally, 2554 grams of water were added to the 5-liter flask over a thirty minute period, and the solution of the polyester acrylate inverted into an aqueous dispersion of Polyester Acrylate 5.

The aqueous dispersion of Polyester Acrylate 5 had a solids concentration of 29.9 weight percent, based on the total weight of the aqueous dispersion of Polyester Acrylate 5, as determined in accordance with the Total Solids Determination procedure provided above. The acid number of Polyester Acrylate 5 was determined to be 53.3 using the Acid Number Determination Procedure set forth above. The aqueous dispersion of Polyester Acrylate 5 had a pH of 8.53 standard pH units at a temperature of about 20° C. The aqueous dispersion of Polyester Acrylate 5 had. a viscosity of 58 seconds, as determined in accordance with Viscosity Determination Procedure #2 provided above using a Ford #4 cup at a sample temperature of 20° C.

### Example 2

### Polyester Acrylate 6

The details of this example in which Polyester Acrylate 6 was formed are identical to the details of “Example 2—Polyester Acrylate 5”, with one exception. Specifically, in this “Example 2—Polyester Acrylate 6”, 211 grams of a VARCUM® 2227 phenolic resin solution were incorporated after the reaction mixture was cooled down to 105° C. Following addition of the VARCUM® 2227 phenolic resin solution, there was a hold period of one hour prior to the addition of dimethylethanolamine and demineralized water that formed the aqueous dispersion of Polyester Acrylate 6. The VARCUM® 2227 phenolic resin solution employed in “Example 2—Polyester Acrylate 6” contained 60 weight percent phenolic resin, based on the total weight of the VARCUM® 2227 phenolic resin solution.

The aqueous dispersion of Polyester Acrylate 6 had a solids concentration of 30.1 weight percent, based on the total weight of the aqueous dispersion of Polyester Acrylate 6, as determined in accordance with the Total Solids Determination procedure provided above. The acid number of Polyester Acrylate 6 was determined to be 33.2 using the Acid Number Determination Procedure set forth above. The aqueous dispersion of Polyester Acrylate 6 had a pH of 8.20 standard pH units at a temperature of about 20° C. The aqueous dispersion of Polyester Acrylate 6 had a viscosity of 41 seconds, as determined in accordance with Viscosity Determination Procedure #2 provided above using a Ford #4 cup at a sample temperature of 20° C.

### Example 2

### Polyester Acrylate 7

The details of this example in which Polyester Acrylate 7 was formed are identical to the details of “Example 2—Polyester Acrylate 5”, with one exception. Specifically, in this “Example 2—Polyester Acrylate 7”, 211 grams of a VARCUM® 2227 phenolic resin solution were incorporated in the polyester resin solution at 132° C. prior to addition of the monomers and initiator to the polyester solution. Thereafter, the remaining details of “Example 2—Polyester Acrylate 5” were followed and culminated in formation of an aqueous dispersion of Polyester Acrylate 7. The VARCUM® 2227 phenolic resin solution employed in “Example 2—Polyester Acrylate 7” contained 60 weight percent phenolic resin, based on the total weight of the VARCUM® 2227 phenolic resin solution.

The aqueous dispersion of Polyester Acrylate 7 had a solids concentration of 29.8 weight percent, based on the total weight of the aqueous dispersion of Polyester Acrylate 7, as determined in accordance with the Total Solids Determination procedure provided above. The acid number of Polyester Acrylate 7 was determined to be 36.7 using the Acid Number Determination Procedure set forth above. The aqueous dispersion of Polyester Acrylate 7 had a pH of 8.14 standard pH units at a temperature of about 20° C. The aqueous dispersion of Polyester Acrylate 7 had a viscosity of 63 seconds, as determined in accordance with Viscosity Determination Procedure #2 provided above using a Ford #4 cup at a sample temperature of 20° C.

### Example 2

### Polyester Acrylate 8

The details of this example in which Polyester Acrylate 8 was formed are identical to the details of “Example 2—Polyester Acrylate 5”, with one exception. Specifically, in this “Example 2—Polyester Acrylate 8”, 211 grams of a VARCUM® 2227 phenolic resin solution were incorporated into the reaction mixture five minutes after addition of dimethylethanolamine and demineralized water to the reaction mixture was complete. This addition of the VARCUM® 2227 phenolic resin solution was followed by a hold of 10 minutes at 90° C. before the final water addition occurred that formed an aqueous dispersion of Polyester Acrylate 8. The VARCUM® 2227 phenolic resin solution employed in “Example 2—Polyester Acrylate 8” contained 60 weight percent phenolic resin, based on the total weight of the VARCUM® 2227 phenolic resin solution.

The aqueous dispersion of Polyester Acrylate 8 had a solids concentration of 29.8 weight percent, based on the total weight of the aqueous dispersion of Polyester Acrylate 8, as determined in accordance with the Total Solids Determination procedure provided above. The acid number of Polyester Acrylate 8 was determined to be 35.0 using the Acid Number Determination Procedure set forth above. The aqueous dispersion of Polyester Acrylate 8 had a pH of 7.85 standard pH units at a temperature of about 20° C. The aqueous dispersion of Polyester Acrylate 8 had a viscosity of 36 seconds, as determined in accordance with Viscosity Determination Procedure #2 provided above using a Ford #4 cup at a sample temperature of 20° C.

### Example 2

### Polyester Acrylate 9

The details of this example in which Polyester Acrylate 9 was formed are identical to the details of “Example 2—Polyester Acrylate 5”, with two exceptions. First, the acrylic acid content was increased from 68.3 grams to 122.4 grams and the ethyl acrylate content was decreased from 321 grams to 268 grams. Second, in this “Example 2—Polyester Acrylate 9”, 211 grams of a VARCUM® 2227 phenolic resin solution were incorporated in the inverted polyester acrylate resin that was at a temperature of about 60° C. after the final water addition to the polyester acrylate resin had been completed. Addition of the VARCUM® 2227 phenolic resin solution was followed by a hold of twenty minutes. The VARCUM® 2227 phenolic resin solution employed in “Example 2—Polyester Acrylate 9” contained 60 weight percent phenolic resin, based on the total weight of the VARCUM® 2227 phenolic resin solution. The inverted resin with the incorporated phenolic resin of the VARCUM® 2227 phenolic resin solution existed as an aqueous dispersion of Polyester Acrylate 9 of this example.

The aqueous dispersion of Polyester Acrylate 9 had a solids concentration of 30.4 weight percent, based on the total weight of the aqueous dispersion of Polyester Acrylate 9, as determined in accordance with the Total Solids Determination procedure provided above. The acid number of Polyester Acrylate 9 was determined to be 52.0 using the Acid Number Determination Procedure set forth above. The aqueous dispersion of Polyester Acrylate 9 had a pH of 8.34 standard pH units at a temperature of about 20° C. The aqueous dispersion of Polyester Acrylate 9 had a viscosity of 42 seconds, as determined in accordance with Viscosity Determination Procedure #2 provided above using a Ford #4 cup at a sample temperature of 20° C.

### Example 2

### Polyester Acrylate 10

The details of this example in which Polyester Acrylate 10 was formed are identical to the details of “Example 2—Polyester Acrylate 9”, with the following exceptions. Specifically, in this “Example 2—Polyester Acrylate 10”, a mixture that included 211 grams of VARCUM® 2227 phenolic resin solution along with 224.8 grams of CYMEL 303 crosslinking agent and 389.4 grams of n-butanol, was incorporated into the reaction mixture five minutes after addition of the dimethylethanolamine and demineralized water to the reaction mixture. Thus, in this example, the VARCUM® 2227 phenolic resin solution was incorporated before the final water addition, whereas the VARCUM® 2227 phenolic resin solution was incorporated after the final water addition in “Example 2—Polyester Acrylate 9.” The addition of the mixture of the VARCUM® 2227 phenolic resin solution, CYMEL 303 crosslinking agent, and n-butanol was followed by a hold of 10 minutes at 80° C.-90° C. before the final water addition to form an aqueous dispersion of Polyester Acrylate 10. The VARCUM® 2227 phenolic resin solution employed in “Example 2—Polyester Acrylate 10” contained 60 weight percent phenolic resin, based on the total weight of the VARCUM® 2227 phenolic resin solution.

The aqueous dispersion of Polyester Acrylate 10 had a solids concentration of 30.8 weight percent, based on the total weight of the aqueous dispersion of Polyester Acrylate 10, as determined in accordance with the Total Solids Determination procedure provided above. The acid number of Polyester Acrylate 10 was determined to be 50.0 using the Acid Number Determination Procedure set forth above. The aqueous dispersion of Polyester Acrylate 10 had a pH of 8.44 standard pH units at a temperature of about 20° C. The aqueous dispersion of Polyester Acrylate 10 had a viscosity of 137 seconds, as determined in accordance with Viscosity Determination Procedure #2 provided above using a Ford #4 cup at a sample temperature of 20° C.

### Example 2

### Polyester Acrylate 11

The details of this example in which Polyester Acrylate 11 was formed are identical to the details of “Example 2—Polyester Acrylate 9”, with two exceptions. First, in this “Example 2—Polyester Acrylate 11”, the free-radical initiated polymerization was conducted at a lower temperature, namely about 121° C., as compared to the 132° C. polymerization employed in “Example 2—Polyester Acrylate 9.” Second, in this “Example 2—Polyester Acrylate 11”, the concentration of the VAZO® 67 free radical initiator was cut by about 40% as compared to the concentration of the VAZO® 67 free radical initiator employed in “Example 2—Polyester Acrylate 9”; thus, only about 11.9 grams of the VAZO® 67 free radical initiator were employed in this “Example 2—Polyester Acrylate 11.” These two changes apparently increased the molecular weight of the acrylate portion of Polyester Acrylate 11 as compared to the molecular weight of Polyester Acrylate 9, even though the formulation of Polyester Acrylate 9 is identical to the formulation of Polyester Acrylate 11.

The aqueous dispersion of Polyester Acrylate 11 had a solids concentration of 29.8 weight percent, based on the total weight of the aqueous dispersion of Polyester Acrylate 11, as determined in accordance with the Total Solids Determination procedure provided above. The acid number of Polyester Acrylate 11 was determined to be 54.2 using the Acid Number Determination Procedure set forth above. The aqueous dispersion of Polyester Acrylate 11 had a pH of 8.09 standard pH units at a temperature of about 20° C. The aqueous dispersion of Polyester Acrylate 11 had a viscosity of 213 seconds, as determined in accordance with Viscosity Determination Procedure #2 provided above using a Ford #4 cup at a sample temperature of 20° C.

### Example 2

### Polyester Acrylate 12

The details of this example in which Polyester Acrylate 12 was formed are identical to the details of “Example 2—Polyester Acrylate 11”, with the exception that the solution of polyester resin was the solution of Polyester Resin F produced in “Example 1—Polyester F.”

The aqueous dispersion of Polyester Acrylate 12 had a solids concentration of 29.9 weight percent, based on the total weight of the aqueous dispersion of Polyester Acrylate 12, as determined in accordance with the Total Solids Determination procedure provided above. The acid number of Polyester Acrylate 12 was determined to be 54.6 using the Acid Number Determination Procedure set forth above. The aqueous dispersion of Polyester Acrylate 12 had a pH of 8.09 standard pH units at a temperature of about 20° C. The aqueous dispersion of Polyester Acrylate 12 had a viscosity of 351 seconds, as determined in accordance with Viscosity Determination Procedure #2 provided above using a Ford #4 cup at a sample temperature of 19° C.

### Example 2

### Polyester Acrylate 13

The details of this example in which Polyester Acrylate 13 was formed are identical to the details of “Example 2—Polyester Acrylate 11”, with the exception that the solution of polyester resin was the solution of Polyester Resin H produced in “Example 1—Polyester H.”

The aqueous dispersion of Polyester Acrylate 13 had a solids concentration of 27.9 weight percent, based on the total weight of the aqueous dispersion of Polyester Acrylate 13, as determined in accordance with the Total Solids Determination procedure provided above. The aqueous dispersion of Polyester Acrylate 13 had a pH of 8.14 standard pH units at a temperature of about 20° C. The aqueous dispersion of Polyester Acrylate 13 had a viscosity of 4965 centipoise at a sample temperature of 25° C., as determined in accordance with Viscosity Determination Procedure #3 provided above in the Property Analysis And Characterization Procedure section of this document using Brookfield LVT Spindle #3 at 12 revolutions per minute (RPM).

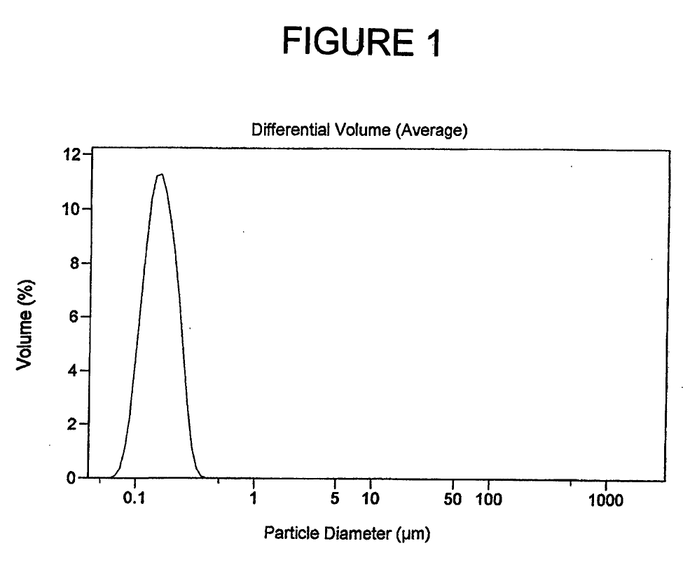

The particles present in the aqueous dispersion of Polyester Acrylate 13 were profiled in accordance with the Particle Size Determination Procedure provided above in the Property Analysis And Characterization Procedure section of this document. Based on the total volume of all particles present in the aqueous dispersion of Polyester Acrylate 13, the particles had a. mean diameter of 0.155 μm (micrometers), a median diameter of 0.154 μm, a mode diameter of 0.155 μm, and a mean diameter to median diameter ratio of 1.004, at a variance of 1.819 μm². A plot of particle diameter versus the volume percent of particles present in the aqueous dispersion of Polyester Acrylate 13 having a particular particle diameter is presented in FIG. 1.

Particles with a diameter of 0.231 μm or more collectively comprised less than 10 percent of the total volume of all particles present in the aqueous dispersion of Polyester Acrylate 13. Particles with a diameter of 0.193 μm or more collectively comprised less than 25 percent of the total volume of all particles present in the aqueous dispersion of Polyester Acrylate 13. Particles with a diameter of 0.154 μm or more collectively comprised less than 50 percent of the total volume of all particles present in the aqueous dispersion of Polyester Acrylate 13. Particles with a diameter of 0.124 μm or more collectively comprised less than 75 percent of the total volume of all particles present in the aqueous dispersion of Polyester Acrylate 13. And finally, particles with a diameter of 0.104 μm or more collectively comprised less than 90 percent of the total volume of all particles present in the aqueous dispersion of Polyester Acrylate 13.

### Example 2

### Polyester Acrylate 14

The details of this example in which Polyester Acrylate 14 was formed are identical to the details of “Example 2—Polyester Acrylate 11”, with the exception that the solution of polyester resin was the solution of Polyester Resin I produced in “Example 1—Polyester I.”

The aqueous dispersion of Polyester Acrylate 14 had a solids concentration of 29 weight percent, based on the total weight of the aqueous dispersion of Polyester Acrylate 14, as determined in accordance with the Total Solids Determination procedure provided above. The aqueous dispersion of Polyester Acrylate 14 had a pH of 8.23 standard pH units at a temperature of about 25° C. The aqueous dispersion of Polyester Acrylate 14 had a viscosity of 243 seconds, as determined in accordance with Viscosity Determination Procedure #2 provided above using a Ford #4 cup at a sample temperature of 25° C.

### Example2

### Polyester Acrylate 15

The details of this example in which Polyester Acrylate 15 was formed are identical to the details of “Example 2—Polyester Acrylate 11”, with the exception that the solution of polyester resin was the solution of Polyester Resin J produced in “Example 1—Polyester J.”

The aqueous dispersion of Polyester Acrylate 15 had a solids concentration of 29.8 weight percent, based on the total weight of the aqueous dispersion of Polyester Acrylate 15, as determined in accordance with the Total Solids Determination procedure provided above. The aqueous dispersion of Polyester Acrylate 15 had a pH of 8.19 standard pH units at a temperature of about 25° C. The aqueous dispersion of Polyester Acrylate 15 had a viscosity of 103 seconds, as determined in accordance with Viscosity Determination Procedure #2 provided above using a Ford #4 cup at a sample temperature of 25° C.

### Example 3

### Preparation of Coating Compositions

In this Example, fifteen different polyester acrylate coating compositions were prepared in accordance with the present invention. Details about preparation of these coating compositions are provided below.

### Example 3

### Coating Composition 1

709.6 grams of the aqueous dispersion of Polyester Acrylate 1 were placed in a flask equipped with a stirrer. 105.2 grams of deionized water, 0.57 grams of CYCAT 600 catalyst, 5.1 grams of DOWANOL® PM propylene glycol methyl ether, 41.4 grams of n-butanol, 18.3 grams of amyl alcohol, 29.1 grams of CYMEL 303 crosslinking agent, and 90.8 grams of deionized water were added to the flask and blended uniformly with the aqueous dispersion of Polyester Acrylate 1 to form 1,000 grams of Coating Composition 1.

Coating Composition 1 was calculated to have a solids concentration of about 24.2 weight percent, based on the total weight of Coating Composition 1. This calculation was based on knowledge from Example 2 that the aqueous dispersion of Polyester Acrylate 1 had a solids concentration of about 30 weight percent, based on the total weight of the aqueous dispersion of Polyester Acrylate 1. Furthermore, this calculation was based on (1) the knowledge from the supplier of the CYCAT 600 catalyst that the CYCAT 600 catalyst had a solids concentration of 100 weight percent, based on the total weight of the CYCAT 600 catalyst, and on (2) the knowledge from the supplier of the CYMEL 303 crosslinking agent that the CYMEL 303 crosslinking agent had a solids concentration of about 98 weight percent, based on the total weight of the CYMEL 303 crosslinking agent.

### Example 3

### Coating Composition 2

709.6 grams of the aqueous dispersion of Polyester Acrylate 2 were placed in a flask equipped with a stirrer. 105.2 grams of deionized water, 0.57 grams of CYCAT 600 catalyst, 5.1 grams of DOWANOL® PM propylene glycol methyl ether, 41.4 grams of n-butanol, 18.3 grams of amyl alcohol, 29.1 grams of CYMEL 303 crosslinking agent, and 90.8 grams of deionized water were added to the flask and blended uniformly with the aqueous dispersion of Polyester Acrylate 2 to form 1,000 grams of Coating Composition 2.

Coating Composition 2 was calculated to have a solids concentration of about 24.2 weight percent, based on the total weight of Coating Composition 2. This calculation was based on knowledge from Example 2 that the aqueous dispersion of Polyester Acrylate 2 had a solids concentration of 30 weight percent, based on the total weight of the aqueous dispersion of Polyester Acrylate 2. Furthermore, this calculation was based on the information set forth in Example 3—Coating Composition 1 about the solids concentration of the CYCAT 600 catalyst and about the solids concentration of the CYMEL 303 crosslinking agent.

### Example 3

### Coating Composition 3

709.6 grams of the aqueous dispersion of Polyester Acrylate 3 were placed in a flask equipped with a stirrer. 105.2 grams of deionized water, 0.57 grams of CYCAT 600 catalyst, 5.1 grams of DOWANOL® PM propylene glycol methyl ether, 41.4 grams of n-butanol, 18.3 grams of amyl alcohol, 29.1 grams of CYMEL 303 crosslinking agent, and 90.8 grams of deionized water were added to the flask and blended uniformly with the aqueous dispersion of Polyester Acrylate 3 to form 1,000 grams of Coating Composition 3.

Coating Composition 3 was calculated to have a solids concentration of about 24.1 weight percent, based on the total weight of Coating Composition 3. This calculation was based on knowledge from Example 2 that the aqueous dispersion of Polyester Acrylate 3 had a solids concentration of 29.9 weight percent, based on the total weight of the aqueous dispersion of Polyester Acrylate 3. Furthermore, this calculation was based on the information set forth in Example 3—Coating Composition 1 about the solids concentration of the CYCAT 600 catalyst and about the solids concentration of the CYMEL 303 crosslinking agent.

### Example 3

### Coating Composition 4

709.6 grams of the aqueous dispersion of Polyester Acrylate 4 were placed in a flask equipped with a stirrer. 105.2 grams of deionized water, 0.57 grams of CYCAT 600 catalyst, 5.1 grams of DOWANOL® PM propylene glycol methyl ether, 41.4 grams of n-butanol, 18.3 grams of amyl alcohol, 29.1 grams of CYMEL 303 crosslinking agent, and 90.8 grams of deionized water were added to the flask and blended uniformly with the aqueous dispersion of Polyester Acrylate 4 to form 1,000 grams of Coating Composition 4.

Coating Composition 4 was calculated to have a solids concentration of about 24.3 weight percent, based on the total weight of Coating Composition 4. This calculation was based on knowledge from Example 2 that the aqueous dispersion of Polyester Acrylate 4 had a solids concentration of 30.2 weight percent, based on the total weight of the aqueous dispersion of Polyester Acrylate 2. Furthermore, this calculation was based on the information set forth in Example 3—Coating Composition 1 about the solids concentration of the CYCAT 600 catalyst and about the solids concentration of the CYMEL 303 crosslinking agent.

### Example 3

### Coating Composition 5

759 grams of the aqueous dispersion of Polyester Acrylate 5 were placed in a flask equipped with a stirrer. 66.4 grams of deionized water, 1 gram of CYCAT 600 catalyst, 33.4 grams of VARCUM® 2227 B55 phenolic resin solution, 47.2 grams of n-butanol, 33.2 grams of CYMEL 303 crosslinking agent, and 59.8 grams of deionized water were added to the flask and blended uniformly with the aqueous dispersion of Polyester Acrylate 5 to form 1,000 grams of Coating Composition 5.

Coating Composition 5 was calculated to have a solids concentration of about 27.8 weight percent, based on the total weight of Coating Composition 5. This calculation was based on knowledge from Example 2 that the aqueous dispersion of Polyester Acrylate 5 had a solids concentration of 29.9 weight percent, based on the total weight of the aqueous dispersion of Polyester Acrylate 5. Furthermore, this calculation was based on the information set forth in Example 3—Coating Composition 1 about the solids concentration of the CYCAT 600 catalyst and about the solids concentration of the CYMEL 303 crosslinking agent. Additionally, this calculation was based on the knowledge from the supplier of the VARCUM® 2227 B55 phenolic resin solution that the VARCUM® 2227 B55 phenolic resin solution had a solids concentration of about 55 weight percent, based on the total weight of the VARCUM® 2227 B55 phenolic resin solution.

### Example 3

### Coating Composition 6

808.3 grams of the aqueous dispersion of Polyester Acrylate 6 were placed in a flask equipped with a stirrer. 65.5 grams of deionized water, 0.64 grams of CYCAT 600 catalyst, 61.5 grams of n-butanol, 32.7 grams of CYMEL 303 crosslinking agent, and 31.4 grams of deionized water were added to the flask and blended uniformly with the aqueous dispersion of Polyester Acrylate 6 to form 1,000 grams of Coating Composition 6.

Coating Composition 6 was calculated to have a solids concentration of about 27.6 weight percent, based on the total weight of Coating Composition 6. This calculation was based on knowledge from Example 2 that the aqueous dispersion of Polyester Acrylate 6 had a solids concentration of 30.1 weight percent, based on the total weight of the aqueous dispersion of Polyester Acrylate 6. Furthermore, this calculation was based on the information set forth in Example 3—Coating Composition 1 about the solids concentration of the CYCAT 600 catalyst and about the solids concentration of the CYMEL 303 crosslinking agent.

### Example 3

### Coating Composition 7

808.3 grams of the aqueous dispersion of Polyester Acrylate 7 were placed in a flask equipped with a stirrer. 65.5 grams of deionized water, 0.64 grams of CYCAT 600 catalyst, 61.5 grams of n-butanol, 32.7 grams of CYMEL 303 crosslinking agent, and 31.4 grams of deionized water were added to the flask and blended uniformly with the aqueous dispersion of Polyester Acrylate 7 to form 1,000 grams of Coating Composition 7.

Coating Composition 7 was calculated to have a solids concentration of about 27.3 weight percent, based on the total weight of Coating Composition 7. This calculation was based on knowledge from Example 2 that the aqueous dispersion of Polyester Acrylate 7 had a solids concentration of 29.8 weight percent, based on the total weight of the aqueous dispersion of Polyester Acrylate 7. Furthermore, this calculation was based on the information set forth in Example 3—Coating Composition 1 about the solids concentration of the CYCAT 600 catalyst and about the solids concentration of the CYMEL 303 crosslinking agent.

### Example 3

### Coating Composition 8

808.3 grams of the aqueous dispersion of Polyester Acrylate 9 were placed in a flask equipped with a stirrer. 65.5 grams of deionized water, 0.64 grams of CYCAT 600 catalyst, 61.5 grams of n-butanol, 32.7 grams of CYMEL 303 crosslinking agent, and 31.4 grams of deionized water were added to the flask and blended uniformly with the aqueous dispersion of Polyester Acrylate 9 to form 1,000 grams of Coating Composition 8.

Coating Composition 8 was calculated to have a solids concentration of about 27.8 weight percent, based on the total weight of Coating Composition 8. This calculation was based on knowledge from Example 2 that the aqueous dispersion of Polyester Acrylate 9 had a solids concentration of 30.4 weight percent, based on the total weight of the aqueous dispersion of Polyester Acrylate 9. Furthermore, this calculation was based on the information set forth in Example 3—Coating Composition 1 about the solids concentration of the CYCAT 600 catalyst and about the solids concentration of the CYMEL 303 crosslinking agent.

Coating Composition 8, as formulated above, exhibited an adequate level of stability during storage. However, the spray coating properties of Coating Composition 8 were somewhat less satisfactory as compared to the spray coating properties of Coating Composition 9. This was apparently due to incorporation of the phenolic resin after inversion of the neutralized polyester acrylate, whereas in Coating Composition 9 that exhibited improved spray coating properties, the phenolic resin was added to the polyester acrylate after neutralization of the polyester acrylate and prior to inversion of the neutralized polyester acrylate.

### Example 3

### Coating Composition 9

808.3 grams of the aqueous dispersion of Polyester Acrylate 8 were placed in a flask equipped with a stirrer. 65.5 grams of deionized water, 0.64 grams of CYCAT 600 catalyst, 61.5 grams of n-butanol, 32.7 grams of CYMEL 303 crosslinking agent, and 31.4 grams of deionized water were added to the flask and blended uniformly with the aqueous dispersion of Polyester Acrylate 8 to form 1,000 grams of Coating Composition 9.

Upon storage of Coating Composition 9 overnight at a temperature of about 38° C. or at room temperature (about 20° C.) for two days, it was observed that Coating Composition 9 was not entirely stable, since a small sediment layer, that was thought to include some of Polyester Acrylate 8, settled out in the storage container. Nonetheless, Coating Composition 9, as formulated above, was generally suitable for spray applications of the coating on internal surfaces of metal food packaging containers and metal beverage packaging containers. Surprisingly, despite the noted stability issues, it was observed that spray coating properties of Coating Composition 9 were improved, apparently by virtue of adding the phenolic resin after neutralization of the polyester acrylate and prior to inversion of the neutralized polyester acrylate, as compared to spray coating properties of Coating Composition 8 in which the phenolic resin was not incorporated until after inversion of the neutralized polyester acrylate.

Coating Composition 9 was calculated to have a solids concentration of about 27.3 weight percent, based on the total weight of Coating Composition 9. This calculation was based on knowledge from Example 2 that the aqueous dispersion of Polyester Acrylate 8 had a solids concentration of 29.8 weight percent, based on the total weight of the aqueous dispersion of Polyester Acrylate 8. Furthermore, this calculation was based on the information set forth in Example 3—Coating Composition 1 about the solids concentration of the CYCAT 600 catalyst and about the solids concentration of the CYMEL 303 crosslinking agent. Coating Composition 9 had a viscosity in the range extending from about 22 secs to about 26 secs, when determined via Viscosity Determination Procedure #2 above using a Ford #4 cup at a sample temperature of 25° C. Coating Composition 9 substantially yielded acceptable coating characteristics when used for internally coating metal food packaging containers and metal beverage packaging containers, though it was a little challenging to fully cover areas of the beverage can which are difficult to uniformly cover, such as the reverse wall section of 2-piece cans, with Coating Composition 9.

### Example 3

### Coating Composition 10

882.4 grams of the aqueous dispersion of Polyester Acrylate 10 were placed in a flask equipped with a stirrer. 88.2 grams of deionized water, 0.64 grams of CYCAT 600 catalyst, 5.4 grams of n-butanol, and 23.4 grams of deionized water were added to the flask and blended uniformly with the aqueous dispersion of Polyester Acrylate 10 to form 1,000 grams of Coating Composition 10.

Coating Composition 10 was calculated to have a solids concentration of about 27.2 weight percent, based on the total weight of Coating Composition 10. This calculation was based on knowledge from Example 2 that the aqueous dispersion of Polyester Acrylate 10 had a solids concentration of 30.8 weight percent, based on the total weight of the aqueous dispersion of Polyester Acrylate 10. Furthermore, this calculation was based on the information set forth in Example 3—Coating Composition 1 about the solids concentration of the CYCAT 600 catalyst.

Upon storage of Coating Composition 10 overnight at a temperature of about 38° C., it was observed that Coating Composition 10 was not entirely stable, since some of Polyester Acrylate 10 settled out in the storage container. Furthermore, it was observed that spray coating properties of Coating Composition 10 were diminished somewhat, apparently by virtue of adding the melamine resin (CYMEL crosslinking agent), butanol, and phenolic resin prior to inversion, as compared to spray coating properties of Coating Composition 9 in which the phenolic resin was incorporated prior to inversion.

### Example 3

### Coating Composition 11

735 grams of the aqueous dispersion of Polyester Acrylate 11 were placed in a flask equipped with a stirrer. 78.6 grams of deionized water, 0.91 grams of CYCAT 600 catalyst, 55.8 grams of n-butanol, 29.7 grams of CYMEL 303 crosslinking agent, and 100 grams of deionized water were added to the flask and blended uniformly with the aqueous dispersion of Polyester Acrylate 11 to form 1,000 grams of Coating Composition 11.

Coating Composition 11 was calculated to have a solids concentration of about 24.9 weight percent, based on the total weight of Coating Composition 11. This calculation was based on knowledge from Example 2 that the aqueous dispersion of Polyester Acrylate 11 had a solids concentration of 29.8 weight percent, based on the total weight of the aqueous dispersion of Polyester Acrylate 11. Furthermore, this calculation was based on the information set forth in Example 3 Coating Composition 1 about the solids concentration of the CYCAT 600. catalyst and about the solids concentration of the CYMEL 303 crosslinking agent.

The reductions of both the temperature and the quantity of incorporated VAZO® 67 free radical initiator during polymerization to form the polyester acrylate increased the molecular weight of the polyester acrylate (Polyester Acrylate 11) and supported the decreased solids content of about 24.9 weight percent for Coating Composition 11, as compared to solids contents greater that 27 weight percent for Coating Compositions 5-10. Coating Composition 11 had a viscosity in the range extending from about 22 secs to about 26 secs when determined in accordance with Viscosity Determination Procedure #2 using a Ford #4 cup at a sample temperature of 25° C. Upon storage of Coating Composition 11 overnight at a temperature of about 37° C. for nineteen days, Coating Composition 11 was observed to be very stable with little if any of Polyester Acrylate 11 settling out in the storage container.

Furthermore, it was observed that spray coating properties of Coating Composition 11 were good and matched up well with some interior can coating compositions of the prior art that contain or liberate BPA or aromatic glycidyl ether compounds (e.g., BADGE, BFDGE and epoxy novalacs). Also, Coating Composition 11, when applied to an aluminum panel as a coating, cured, and then subjected to the TNO Global Migration Test (See Property Analysis And Characterization Procedure section above), exhibited a value of 4±1 mg of extract per 10 dm² of the coated aluminum panel, which is well within the level of acceptable results under the TNO Global Migration Test. When tested according to Corrosion Test Procedure No. 2 (See Property Analysis And Characterization Procedure section above), a metal can with a cured coating made from Coating Composition 11 had a visual appearance that was only slightly diminished compared to a metal can with a cured coating made from an existing standard commercial water-based coating composition.

Coating Composition 11, as formulated above, was very suitable for spray applications of the coating on internal surfaces of metal food packaging containers and metal beverage packaging containers. Spray coating properties of Coating Composition 11 were very suitable, apparently by virtue of adding the phenolic resin after neutralization of the polyester acrylate, but prior to inversion of the neutralized polyester acrylate. Coating Composition 11 substantially yielded good coating characteristics (per the Coating Spreadability/Wetting Evaluation procedure provided in the Property Analysis And Characterization Procedure section of this document) and minimal to no blistering (rated good to excellent per the Blistering Evaluation procedure provided in the Property Analysis And Characterization Procedure section of this document), when used for internally coating metal food packaging containers and metal beverage packaging containers. Spray applications of Coating Composition 11 readily achieved full coverage of areas of the beverage can that are sometimes difficult to cover, such as the reverse wall section of 2-piece cans.

### Example 3

### Coating Composition 12

735 grams of the aqueous dispersion of Polyester Acrylate 12 were placed in a flask equipped with a stirrer. 78.6 grams of deionized water, 0.91 grams of CYCAT 600 catalyst, 55.8 grams of n-butanol, 29.7 grams of CYMEL 303 crosslinking agent, and 100 grams of deionized water were added to the flask and blended uniformly with the aqueous dispersion of Polyester Acrylate 12 to form 1,000 grams-of Coating Composition 12.

Coating Composition 12 was calculated to have a solids concentration of about 25.0 weight percent, based on the total weight of Coating Composition 12. This calculation was based on knowledge from Example 2 that the aqueous dispersion of Polyester Acrylate 12 had a solids concentration of 29.9 weight percent, based on the total weight of the aqueous dispersion of Polyester Acrylate 12. Furthermore, this calculation was based on the information set forth in Example 3—Coating Composition 1 about the solids concentration of the CYCAT 600 catalyst and about the solids concentration of the CYMEL 303 crosslinking agent.

Upon storage of Coating Composition 12 overnight, it was observed that Coating Composition 12 was not entirely stable, since some of the Polyester Acrylate 12 settled out in the storage container, whereas the related Coating Composition 13 exhibited better stability characteristics. Nonetheless, it was observed that spray-coating properties of Coating Composition 12 were generally good in all aspects (per the Coating Spreadability/Wetting Evaluation procedure provided in the Property Analysis And Characterization Procedure section of this document). Also, spray applications of Coating Composition 12 generally exhibited minimal to no blistering (rated good to excellent per the Blistering Evaluation procedure provided in the Property Analysis And Characterization Procedure section of this document).

### Example 3

### Coating Composition 13

697.4 grams of the aqueous dispersion of the neutralized Polyester Acrylate 13 were placed in a flask equipped with a stirrer. 97.8 grams of deionized water, 0.79 grams of CYCAT 600 catalyst, 48.8 grams of n-butanol, 26.1 grams of CYMEL 303 crosslinking agent, and 129.2 grams of deionized water were added to the flask and blended uniformly with the aqueous dispersion of Polyester Acrylate 13 to form 1,000 grams of Coating Composition 13.

Coating Composition 13 was calculated to have a solids concentration of about 22.1 weight percent, based on the total weight of Coating Composition 13. This calculation was based on knowledge from Example 2 that the aqueous dispersion of Polyester Acrylate 13 had a solids concentration of 27.9 weight percent, based on the total weight of the aqueous dispersion of Polyester Acrylate 13. Furthermore, this calculation was based on the information set forth in Example 3—Coating Composition 1 about the solids concentration of the CYCAT 600 catalyst and about the solids concentration of the CYMEL 303 crosslinking agent. Coating Composition 13 had a viscosity in the range extending from about 22 secs to about 26 secs when determined in accordance with Viscosity Determination Procedure #2 using a Ford #4 cup at a sample temperature of 25° C.

The reduction in the temperature during polymerization to form the polyester acrylate apparently increased the molecular weight of the polyester acrylate (Polyester Acrylate 13) and apparently supported the decreased solids content of about 22.1 weight percent for Coating Composition 13. Upon storage of Coating Composition 13 overnight at a temperature of about 37° C. for greater than two weeks, Coating Composition 13 was observed to be very stable with little if any of Polyester Acrylate 13 settling out in the storage container. Coating Composition 13, as formulated above, was very suitable for spray applications of the coating on internal surfaces of metal food packaging containers and metal beverage packaging containers.

Coating Composition 13 yielded excellent coating characteristics (per the Coating Spreadability/Wetting Evaluation procedure provided in the Property Analysis And Characterization Procedure section of this document) and no blistering (rated excellent per the Blistering Evaluation procedure provided in the Property Analysis And Characterization Procedure section of this document), when used for internally coating metal food packaging containers and metal beverage packaging containers. Spray coatings of Coating Composition 13 readily achieved full coverage of areas of the beverage can that are sometimes difficult to cover, such as the reverse wall section of 2-piece cans.

### Example 3

### Coating Composition 14

715.7 grams of the aqueous dispersion of Polyester Acrylate 14 were placed in a flask equipped with a stirrer. 139.3 grams of deionized water, 0.87 grams of CYCAT 600 catalyst, 53.7 grams of n-butanol, 28.7 grams of CYMEL 303 crosslinking agent, and 61.8 grams of deionized water were added to the flask and blended uniformly with the aqueous dispersion of Polyester Acrylate 14 to form 1,000 grams of Coating Composition 14.

Coating Composition 14 was calculated to have a solids concentration of about 23.6 weight percent, based on the total weight of Coating Composition 14. This calculation was based on knowledge from Example 2 that the aqueous dispersion of Polyester Acrylate 14 had a solids concentration of 29 weight percent, based on the total weight of the aqueous dispersion of Polyester Acrylate 14. Furthermore, this calculation was based on the information set forth in Example 3—Coating Composition 1 about the solids concentration of the CYCAT 600 catalyst and about the solids concentration of the CYMEL 303 crosslinking agent.

The reduction in the temperature during polymerization to form the polyester acrylate apparently increased the molecular weight of the polyester acrylate (Polyester Acrylate 14) and apparently supported the decreased solids content of about 23.6 weight percent for Coating Composition 14, as compared to solids contents greater than 27 weight percent for Coating Compositions 5-10 and as compared to the solid content approaching 25 weight percent for Coating Composition 11. Upon storage of Coating Composition 14 overnight at a temperature of about 37° C. for greater than two weeks, Coating Composition 14 was observed to be very stable with little if any of Polyester Acrylate 14 settling out in the storage container. Furthermore, it was observed that spray-coating properties of Coating Composition 14 were generally good in all aspects (per the Coating Spreadability/Wetting Evaluation procedure provided in the Property Analysis And Characterization Procedure section of this document). Also, spray applications of Coating Composition 14 generally exhibited minimal to no blistering (rated good to excellent per the Blistering Evaluation procedure provided in the Property Analysis. And Characterization Procedure section of this document).

### Example 3

### Coating Composition 15

751.9 grams of the aqueous dispersion of Polyester Acrylate 15 were placed in a flask equipped with a stirrer. 132 grams of deionized water, 0.92 grams of CYCAT 600 catalyst, 56.5 grams of n-butanol, 30.1 grams of CYMEL 303 crosslinking agent, and 28.8 grams of deionized water were added to the flask and blended uniformly with the aqueous dispersion of Polyester Acrylate 15 to form 1,000 grams of Coating Composition 15.

Coating Composition 15 was calculated to have a solids concentration of about 25.4 weight percent, based on the total weight of Coating Composition 15. This calculation was based on knowledge from Example 2 that the aqueous dispersion of Polyester Acrylate 15 had a solids concentration of 29.8 weight percent, based on the total weight of the aqueous dispersion of Polyester Acrylate 15. Furthermore, this calculation was based on the information set forth in Example 3—Coating Composition 1 about the solids concentration of the CYCAT 600 catalyst and about the solids concentration of the CYMEL 303 crosslinking agent. Upon storage of Coating Composition 15 overnight at a temperature of about 37° C. for a few days, it was observed that Coating Composition 15 did not exhibit an adequate degree of stability, since a significant sediment layer, that was thought to include some of Polyester Acrylate 15, settled out in the storage container.

### Example 4

### Can Spray Results Using Coating Compositions 13 and 14

A test was conducted using Coating Composition 13 and Coating Composition 14. First, commercially available spray equipment with typical commercial spray settings was employed to spray coat different weights of Coating Composition 13 onto internal surfaces of the body and integral end (bottom) portions of 2-piece drawn and ironed tinplate cans and aluminum cans. The coating application occurred through the open end of each can prior to attachment of the separately formed end (top) portion onto the open end of the body portion. Nine different runs employing varying ranges of coating weights on a total of seventy-eight different cans (i.e.: up to 12 cans per run) were conducted using Coating Composition 13.

Additionally, the same spray equipment used to apply Coating Composition 13 was employed, using typical commercial spray settings, to spray coat different weights of Coating Composition 14 onto internal surfaces of the body and integral end (bottom) portions of 2-piece drawn and ironed tinplate cans and aluminum cans. The coating application again occurred through the open end of each can prior to attachment of the separately formed end (top) portion onto the open end of the body portion. Nine different runs employing varying ranges of coating weights on seventy-three different cans (i.e.: up to nine cans per run) were conducted using Coating Composition 14.

Can coatings formed of Coating Composition 13 were rated excellent using the Coating Spreadability/Wetting Evaluation procedure described in the Property Analysis And Characterization Procedure section of this document. Can coatings formed of Coating Composition 14 were rated very good using the Coating Spreadability/Wetting Evaluation procedure. The can coatings of Coating Composition 14 were slightly whiter and foamier than the can coatings of Coating Composition 13.

After being spray coated, each can was placed in a thermal oven for about one minute to about five minutes at a temperature in the range from about 150° C. to about 250° C. to cure the applied coating composition. The coatings on the different cans of the various runs for both Coating Composition 13 and Coating Composition 14 were each cured for about the same amount of time at about the same curing temperature, to minimize any differential enamel rating effects attributable to differential curing conditions.

None of the can coatings formed of Coating Composition 13 in Runs 3 through 9 exhibited any visually observable blistering and were all therefore rated excellent using the Blistering Evaluation procedure described in the Property Analysis And Characterization Procedure section of this document. Some can coatings formed of Coating Composition 13 in Run 2 exhibited a few blisters and were therefore rated good using the Blistering Evaluation procedure; the other can coatings from Run 2 received an excellent rating. Most of the can coatings formed of Coating Composition 13 in Run 1 exhibited frequent blisters and were therefore rated fair using the Blistering Evaluation procedure.

None of the can coatings formed of Coating Composition 14 in Runs 3 through 9 exhibited any visually observable blistering and were all therefore rated excellent using the Blistering Evaluation procedure. Two of the eight can coatings formed of Coating Composition 14 in Run 2 exhibited a few blisters and were therefore rated good using the Blistering Evaluation procedure; the other six can coatings in run 2 received an excellent rating. Most of the can coatings formed of Coating Composition 14 in Run 1 exhibited frequent blisters and were therefore rated fair using the Blistering Evaluation procedure.

Enamel ratings for each can of each run for the applications of Coating Composition 13 and the applications of Coating Composition 14 were made in accordance with the Coating Uniformity/Metal Exposure test procedure provided above. The enamel rating is the current in milliamps passing through the coated can body that contains a salt solution electrolyte. The enamel rating reveals the extent to which all interior surfaces of a particular can have been evenly coated by a particular spray-applied coating composition.—any exposed uncoated metal will give a high current reading. A typical industrial customer specification requires an enamel rating of <1 mA after application of one 160 mg. coating on a 33 cl. tinplate beverage can. The enamel ratings for all of the cans coated with Coating Composition 13 are provided in Table 2 below, and the enamel ratings for all of the cans coated with Coating Composition 14 are provided in Table 3 below.

TABLE 2
Performance of Coating Composition No. 13

| | | Enamel Rating (mA) | | | | | | | | | | | | | | | |
|---|---|---|---|---|---|---|---|---|---|---|---|---|---|---|---|---|---|
| | Coating Weight | | | | | | | | | | | | | Run | Std. | No. Of | Can |
| Run | (Mg/33 cl can) | Individual Cans | | | | | | | | | | | | Avg | Dev. | Coats | Metal |
| 1 | 170.177 | 0.28 | 1.42 | 1.44 | 1.63 | 0.86 | 0.07 | 0.13 | 0.04 | 2.67 | 0.27 | 0.18 | 0.10 | 0.76 | 0.85 | 1 | Tinplate |
| 2 | 161.162 | 0.11 | 0.20 | 0.11 | 0.05 | 0.2 | 0.06 | 0.09 | 0.21 | 0.05 | 0.27 | | | 0.14 | 0.08 | 1 | Tinplate |
| 3 | 143.140 | 0.12 | 0.22 | 0.33 | 0.80 | 0.24 | 0.07 | 0.08 | 0.16 | | | | | 0.25 | 0.24 | 1 | Tinplate |
| 4 | 120.122 | 0.43 | 0.20 | 2.34 | 0.33 | 0.20 | 0.23 | 1.79 | 0.50 | | | | | 0.73 | 0.85 | 1 | Tinplate |
| 5 | 152.151 | 0.02 | 0.03 | 0.04 | 0.05 | 0.09 | 1.62 | 0.08 | 0.04 | | | | | 0.25 | 0.56 | 1 | Aluminum |
| 6 | 102.102 | 2.41 | 9.51 | 0.19 | 2.96 | 2.91 | 2.28 | 1.81 | 4.21 | | | | | 3.29 | 2.76 | 1 | Tinplate |
| 7 | 312.312 | 0.01 | 0.01 | 0.01 | 0.01 | 0.02 | 0.01 | 0.01 | 0.06 | | | | | 0.02 | 0.02 | 2 | Tinplate |
| 8 | 117.117 | 0.09 | 33.7 | 22.3 | 14.6 | 0.06 | 28.0 | | | | | | | 16.46 | 14.18 | 1 | Aluminum |
| 9 | 103 | 14.7 | 72.9 | 90.5 | 122.5 | 82.8 | 55.5 | 72.9 | | | | | | 73.11 | 33.06 | 1 | Aluminum |

TABLE 3
Performance of Coating Composition No. 14

| | Coating | Enamel Rating (mA) | | | | | | | | | | | No. | |
|---|---|---|---|---|---|---|---|---|---|---|---|---|---|---|
| | Weight (Mg/ | | | | | | | | | | Run | Std. | Of | Can |
| Run | 33 cl can) | Individual Cans | | | | | | | | | Avg | Dev. | Coats | Metal |
| 1 | 190.194 | 0.13 | 0.11 | 3.59 | 0.10 | 3.35 | 4.45 | 0.16 | 0.31 | 0.20 | 1.38 | 0.18 | 1 | Tinplate |
| 2 | 172.175 | 0.10 | 4.64 | 1.45 | 0.08 | 0.16 | 0.11 | 1.04 | 0.18 | | 0.97 | 0.16 | 1 | Tinplate |
| 3 | 154.154 | 0.11 | 0.10 | 1.66 | 1.98 | 0.35 | 0.10 | 0.40 | 0.04 | | 0.59 | 0.08 | 1 | Tinplate |
| 4 | 131.132 | 0.18 | 0.48 | 0.41 | 0.96 | 1.74 | 2.84 | 0.39 | 3.53 | | 1.32 | 0.13 | 1 | Tinplate |
| 5 | 111.112 | 8.20 | 2.44 | 5.37 | 0.64 | 0.61 | 1.27 | 7.71 | 1.27 | | 3.44 | 0.32 | 1 | Tinplate |
| 6 | 326 | 0.00 | 0.02 | 0.01 | 0.07 | 0.02 | 0.00 | 0.01 | 0.01 | | 0.02 | 0.02 | 1 | Tinplate |
| 7 | 145.145 | 78.2 | 2.00 | 0.05 | 39.5 | 05.3 | 13 | 22.6 | 69.1 | | 28.72 | 30.6 | 2 | Aluminum |
| 8 | 121.123 | 150 | 164 | 192.3 | 172.5 | 152.1 | 99.7 | 116.5 | 175.5 | | 152.80 | 31.0 | 1 | Aluminum |
| 9 | 163.165 | 0.38 | 0.08 | 0.06 | 0.04 | 0.05 | 1.34 | 0.26 | 0.04 | | 0.28 | 0.45 | 1 | Aluminum |

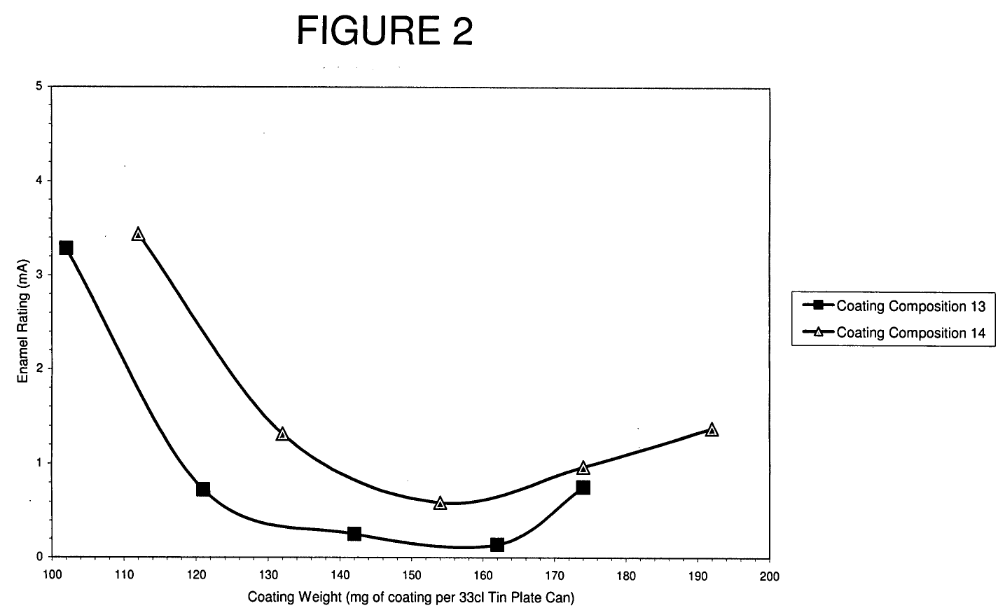

“33 cl.” tinplate and aluminum cans were employed during this spray coating test of Compositions 13 and 14. The designation “33 cl.” refers to the can volume, which was 33 centilitres during this testing of Coating Compositions 13 and 14. 33 cl. is a common volume for beverage cans in Europe. The coating weight (in mg) for each can was determined by weighing each can before the coating composition was spray applied to the can and again after cure of the coating composition in the thermal oven was complete. Thus, the coating weights shown in Table 2 and in Table 3 and in the graph of FIG. 2 (discussed below) are dry coating weights after removal of water and solvent(s) from the original coating composition and after any crosslinking effected by the cure.

The results of enamel rating determinations versus cured coating weight for the coated tinplate cans (see Tables 2 and 3) of this example for both Coating Composition 13 and Coating Composition 14 are graphically presented in FIG. 2. The two plots presented in FIG. 2 demonstrate both Coating Composition 13 and Coating Composition 14 meet the typical industrial customer specification requiring an enamel rating of <1 mA after application of one 160 mg. coating on a 33 cl. tinplate beverage can. However, the two plots presented in FIG. 2 further show Coating Composition 13 has a broader spray latitude that allows the typical industrial customer specification requiring an enamel rating of <1 mA (after application of one 160 mg coating) to be met at lower coating weights than Coating Composition 14.

Additionally, metal beverage cans containing cured internal coatings (liners) formed of Coating Composition 13 were tested according to Corrosion Test Procedure No. 1 that is presented in the Property Analysis And Characterization Procedure section of this document. Both aluminum and tinplate cans were included in the testing. The internally lined aluminum cans and the internally lined tinplate cans were each filled with a diet cola, Diet Sprite® soft drink, an isotonic drink, or beer and sealed in conventional commercial fashion for beverage containers. The filled cans were divided into groups of filled cans stored at one of two different temperatures (20° C. or 37° C.) for one of two different storage durations (six weeks or three months). The numerical ratings provided to the different cans upon completion of the different storage durations at the different temperatures are provided in Table 4:

TABLE 4
Corrosion Performance of Coating Composition No. 13

| | | Can Metal | | | | | | | |
|---|---|---|---|---|---|---|---|---|---|
| | | Aluminum | Aluminum | Aluminum | Aluminum | Tinplate | Tinplate | Tinplate | Tinplate |
| | | Storage Temperature | | | | | | | |
| | | 20° C. | 20° C. | 37° C. | 37° C. | 20° C. | 20° C. | 37° C. | 37° C. |
| | | Storage Duration | | | | | | | |
| | | 6 Weeks | 3 Months | 6 Weeks | 3 Months | 6 Weeks | 3 Months | 6 Weeks | 3 Months |
| Beverage | Diet Cola | 5 | 5 | 5 | 5 | 4 | 4 | 4 | 3 |
| | Diet Sprite ® | 5 | 5 | Not Rated | Not Rated | 5 | 4 | 4 | 1 |
| | Isotonic Drink | 4 | 5 | 4 | 3 | 4 to 5 | 4 to 5 | 4 | 3 to 4 |
| | Beer | 5 | 5 | 5 | 5 | 4 | 4 | 4 | 4 |

Also, metal beverage cans containing cured internal coatings (liners) formed of Coating Composition 13 were tested in a fashion similar to the procedure set forth in Corrosion Test Procedure No. 2 of the Property Analysis And Characterization Procedure section of this document. Metal cans were used in place of the metal panels mentioned in Corrosion Test Procedure No. 2. Both aluminum and tinplate cans were included in the testing. The internally lined aluminum cans and the internally lined tinplate cans were each filled with the acid+salt solution and held under the conditions specified in Corrosion Test Procedure No. 2.

At the end of the five day test period, the acid+salt solution was emptied from the cans and the presence or absence of any corrosion and blush inside the containers was visually observed, rated, and noted. The corrosion rating scale used extended from a rating of zero (severe corrosion visually present) to a rating of 10 (no corrosion visually present). The blush rating scale used extended from a rating of zero (substantial blushing visually present) to a rating of 10 (no blushing visually present). As used herein, “Blushing” means a defect in a polymeric coating which manifests itself as a milky appearance on or near the exposed surface of the coating. The numerical ratings provided to the aluminum and tinplate cans upon completion of the described variation of Corrosion Test Procedure No. 2 are provided in Table 5:

TABLE 5
Corrosion Performance of Coating Composition No. 13

| Can Metal | Aluminum | Tinplate |
|---|---|---|
| Test Temperature | 60° C. | 60° C. |
| Test Duration | 5 | 5 |
| | days | days |
| Corrosion Rating | 9 | 6 |
| Blush Rating | 10 | 10 |

Tinplate beverage cans containing cured internal coatings (liners) formed of Coating Composition 13 were tested using the procedure set forth in Corrosion Test Procedure No. 3 that is presented in the Property Analysis And Characterization Procedure section of this document. The test period was ten days at the test temperature of 37° C. The results of this test, which was conducted on twelve different tinplate beverage cans, are presented in Table 6:

TABLE 6
Corrosion Performance of Coating Composition No. 13

| CAN NUMBER | IRON CONCENTRATION (PPM) |
|---|---|
| 1 | 0.16 |
| 2 | 0.18 |
| 3 | 0.08 |
| 4 | 0.08 |
| 5 | 0.03 |
| 6 | 0.26 |
| 7 | 0.16 |
| 8 | 0.75 |
| 9 | 0.17 |
| 10 | 0.39 |
| 11 | 0.51 |
| 12 | 0.31 |
| Average of Twelve Cans | 0.26 |
| Maximum of Twelve Cans | 0.75 |

Thus, the tinplate beverage cans met the corrosion standard set forth in Corrosion Test Procedure No. 3.

Metal beverage cans containing cured internal coatings (liners) formed of Coating Composition 13 were also subjected to the Adhesion Evaluation Procedure that is presented in the Property Analysis And Characterization Procedure section of this document. Only tinplate cans were included in this testing. Prior to undergoing the adhesive evaluation, the internal linings of the different tinplate cans were subjected to one of four different exposure treatments. The four different exposure treatments were Water Pasteurization (exposure to 85° C. water for thirty minutes); Joy Pasteurization (exposure to a 5 volume percent solution of JOY® liquid dish detergent in water at 82° C. for thirty minutes); Water Sterilization (exposure to 121° C. water for ninety minutes); and MSE Pasteurization (exposure to an aqueous solution containing 2 weight percent lactic acid, 2 weight percent salt, and 1.3 weight percent acetic acid, based on the total solution weight, at 100° C. for fifteen minutes).

At the end of each of the different exposure treatments, the internally lined tinplate cans were emptied and subjected to the crosshatching, tape application and removal, and rating according to the Adhesion Evaluation Procedure. Also, the presence or absence of any corrosion and blush inside the empty, internally lined cans was visually observed, rated, and noted. The blush rating scale extended from a rating of zero (substantial blushing visually present) to a rating of 10 (no blushing visually present). The numerical ratings provided to the internally lined tinplate cans upon completion of the Adhesion Evaluation Procedure and the blushing rating are provided in Table 6:

TABLE 6
Adhesion and Anti-Blushing Performance of Coating Composition No. 13

| | Adhesion | Adhesion | | |
|---|---|---|---|---|
| | Rating | Rating | | |
| | (Dome | (Sidewall | Blush | |
| Exposure Treatment | of Can) | of Can) | Rating | Corrosion |
| Water Pasteurization | GT 1 | GT 0 | 10 | — |
| Joy Pasteurization | GT 0 | GT 0 | 9 | — |
| Water Sterilization | GT 0 | GT 0 | 9 | — |
| MSE Pasteurization | GT 0 | GT 0 | 10 | None |

Seven out of eight of the Adhesion Ratings were GT 0 which indicates 100% of the coating in the tested area maintained adhesion during the tape removal operation of the Adhesion Evaluation Procedure. All of the Blush Ratings indicated no or only minor blushing present on the cured coating based on Coating Composition 13. Also, for the cans subjected to the potentially corrosive MSE Pasteurization, no corrosion was visually observed.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. An article, the article comprising:
a metal container having an interior surface and an exterior surface; and
a coating on at least a portion of the interior surface of the container, the coating comprising an aqueous dispersion of an at least partially neutralized polyester acrylate, the polyester acrylate being a reaction product of:
a polyester, the polyester a reaction product of a first collection of components, the first collection of components comprising:
a polybasic acid that contains at least two carboxyl groups; and
a polyhydric alcohol that contains at least two hydroxyl groups; and
a second collection of components, the second collection of components comprising:
a (meth)acrylic acid ester; and
an ethylenically unsaturated mono- or multi-functional acid.

2. An article, the article comprising:
a metal container having an interior surface and an exterior surface; and
a coating on at least a portion of the interior surface of the container, the coating comprising an aqueous dispersion of an at least partially neutralized polyester acrylate, wherein the coating is substantially free of mobile BPA and aromatic glycidyl ether compounds.

3. An article, the article comprising:
a metal container having an interior surface and an exterior surface, the interior surface defining a space within the metal container;
a liner attached to and covering the interior surface of the container, the liner derived from a coating composition comprising an aqueous dispersion of an at least partially neutralized polyester acrylate; and
a beverage or a wet foodstuff located within the space and in contact with the liner.

4. A method, the method comprising:
providing a metal container having an interior surface and an exterior surface;
providing a coating composition, the coating composition comprising an aqueous dispersion of an at least partially neutralized polyester acrylate, the polyester acrylate being a reaction product of:
a polyester, the polyester a reaction product of a first collection of components, the first collection of components comprising:
a polybasic acid that contains at least two carboxyl groups;
a polyhydric alcohol that contains at least two hydroxyl groups; and
a second collection of components, the second collection of components comprising:
a (meth)acrylic acid ester; and
an ethylenically unsaturated mono- or multi-functional acid; and
applying the coating composition on at least a portion of the interior surface of the container.

5. The method of claim 4, the method further comprising allowing the coating composition to solidify and form a protective liner on the interior surface of the container.

6. The method of claim 4 wherein the coating composition is completely free of mobile BPA and aromatic glycidyl ether compounds.

7. The method of claim 4 wherein applying the coating composition comprises spraying the coating composition.

8. The method of claim 4 wherein the container comprises a container body portion with an interior surface and wherein applying the coating composition comprises applying the coating composition on at least a portion of the interior surface of the container body.

9. The method of claim 4 wherein the container comprises a container body portion with an interior surface and a container end portion with an interior surface, and wherein applying the coating composition comprises applying the coating composition on at least a portion of the interior surface of the container end portion.

10. The method of claim 4 wherein the polybasic acid comprises terephthalic acid, isophthalic acid, dimethylterephthalate, adipic acid, cyclohexanedicarboxylic acid, or any combination of any of these in any proportion.

11. The method of claim 4 wherein the concentration of the polyhydric alcohol in the first collection of components is at least about 20 weight percent, based on the total weight of the first collection of components.

12. The method of claim 4 wherein the polyhydric alcohol comprises ethylene glycol, propylene glycol, trimethylolpropane, cyclohexanedimethanol, or any combination of any of these in any proportion.

13. The method of claim 4 wherein the first collection of components further comprises an anhydride of a second polybasic acid, the second polybasic acid containing at least two carboxyl groups.

14. The method of claim 13 wherein the anhydride comprises maleic anhydride.

15. The method of claim 13 wherein the concentration of the anhydride ranges up to about 40 weight percent, based on the total weight of the first collection of components.

16. The method of claim 4 wherein the concentration of the (meth)acrylic acid ester in the second collection of components ranges from as low as about 40 weight percent to as high as about 70 weight percent, based on the total weight of the second collection of components.

17. The method of claim 4 wherein the (meth)acrylic acid ester comprises ethyl acrylate.

18. The method of claim 4 wherein the ethylenically unsaturated mono- or multi-functional acid comprises acrylic acid.

19. The method of claim 4 wherein the second collection of components further comprises a vinyl compound.

20. A method, the method comprising:
providing a metal container having an interior surface and an exterior surface;
providing a coating composition, the coating composition comprising an aqueous dispersion of an at least partially neutralized polyester acrylate, the coating composition substantially free of mobile BPA and aromatic glycidyl ether compounds; and
applying the coating composition on at least a portion of the interior surface of the container.

21. A method, the method comprising:
providing a metal container having an interior surface and an exterior surface, the interior surface defining a space within the metal container, the container comprising a liner attached to and covering the interior surface of the container, the liner derived from an aqueous dispersion of an at least partially neutralized polyester acrylate; and
holding a beverage or a wet foodstuff within the space and in contact with the liner.

22. The method of claim 21 wherein the polyester acrylate is a reaction product of a polyester and a first collection of components, the first collection of components comprising an acrylic monomer and an ethylenically unsaturated mono- or multi-functional acid.

23. The method of claim 22 wherein the polyester is a reaction product of a second collection of components, the second collection of components comprising:
a polybasic acid that contains at least two carboxyl groups; and
a polyhydric alcohol that contains at least two hydroxyl groups.

24. The method of claim 21, wherein the liner is substantially free of mobile BPA and aromatic glycidyl ether compounds.

25. The method of claim 21, wherein the container comprises a container body portion with an interior surface and a container end portion with an interior surface, the container body portion and the container end portion enclosing the space within the container, the liner attached to and covering the interior surface of the container end portion.

26. The method of claim 21 wherein the beverage or wet foodstuff exhibits an acidic pH.
